(19) United States
(12) Patent Application Publication
(10) Pub. No.: US 2026/0195793 A1
(43) Pub. Date: Jul. 9, 2026

(54) ATTRIBUTION AND INCREMENTALITY FOR BROADCAST MEDIA

(71) Applicant: Claritas, LLC, Cincinnati, OH (US)

(72) Inventor: Jason Rex Briggs, Galena Forrest, NV (US)

(21) Appl. No.: 19/440,436

(22) Filed: Jan. 5, 2026

Related U.S. Application Data
(60) Provisional application No. 63/742,177, filed on Jan. 6, 2025.

(51) Int. Cl. G06Q 30/0242

(52) U.S. Cl. CPC G06Q 30/0246

(57) ABSTRACT

A method comprising receiving an event log corresponding to a broadcast media promotional cycle. The event log comprises entries, and each entry comprises at least region data, date data, and promotion placement data. The event log is processed to determine a first conversion rate. A subset of the event log is processed to determine a second conversion rate. An incrementality value is determined based on the first conversion rate and the second conversion rate. A baseline attribution corresponding to at least one broadcast media promotional item of the broadcast media promotional cycle is determined. An incremental contribution is determined by applying the incrementality value to the baseline attribution. One or more performance measurements are determined based on the incremental. The incremental contribution and/or the one or more performance measurements are provided to a user device.

### RELATED APPLICATION

This application claims the benefit under 35 U.S.C. §119(e) of U.S. Provisional Patent Application No. 63/742,177, titled “Attribution and Incrementality for Broadcast Media,” filed on January 6, 2025, the entire content of which is incorporated herein by reference.

### TECHNICAL FIELD

This disclosure relates to the field of artificial intelligence, and in particular to determining attribution and incrementality for broadcast media.

### BACKGROUND

Advertising can refer to a form of communication used by businesses, organizations, or individuals to promote products, services, ideas, or brands to a target audience. Advertisers can implement an integrated marketing plan that includes multiple types of advertising, including, for example, broadcast advertising and digital advertising. Digital advertising can be described as the promotion of products, services, or brands through online platforms and digital channels. Digital advertising can include various formats, such as display advertisements, search engine advertisements, social media advertisements, video advertisements, and influencer partnerships. Digital advertising can leverage data-driven targeting to reach specific audiences, measure performance in real time, and optimize campaigns for effectiveness and return on investment.

Broadcast advertising can be described as a form of mass communication, where promotional messages are delivered to large audiences through broadcast mediums, such as television, radio, and/or satellite audio. Broadcast advertising can include creating and airing commercials, jingles, and/or sponsored content to inform, persuade, or remind consumers about products, services, or brands. Broadcast advertising is characterized by its ability to reach a wide population simultaneously, and is often used for brand awareness and mass-market appeal. Because broadcast advertising reaches a wide population simultaneously without addressability (that is, unlike digital or direct mail, broadcast is not delivered on a per person or household basis), it can be difficult to accurately measure its performance, effectiveness, and/or return on investment, especially compared to digital advertising.

### BRIEF DESCRIPTION OF THE DRAWINGS

The present disclosure will be understood more fully from the detailed description given below and from the accompanying drawings of various embodiments of the present disclosure, which, however, should not be taken to limit the present disclosure to the specific embodiments, but are for explanation and understanding only.

FIG. 1 illustrates an example of a system architecture for implementations of the present disclosure.

FIG. 2 depicts a flow diagram of a method for determining attribution and incrementality for broadcast media, in accordance with one or more aspects of the present disclosure.

FIG. 3 depicts an example of the input features for the AI model, in accordance with one or more aspects of the present disclosure.

FIG. 4A depicts an example impressions versus conversions graph illustrating the relationship between promotion impressions and conversion across multiple regions (e.g., DMA), in accordance with one or more aspects of the present disclosure.

FIG. 4B depicts an example promotion versus conversions graph illustrating the relationship between exposure levels and the share of conversions across multiple regions, in accordance with one or more aspects of the present disclosure.

FIG. 4C depicts an example exposure chart illustrating the distribution of exposure across multiple regions, in accordance with one or more aspects of the present disclosure

FIG. 4D depicts an example KPI impact graph illustrating the relationship between exposure and KPI impact, in accordance with one or more aspects of the present disclosure.

FIGS. 5A depicts an example time series prediction graph illustrating the relationship between predicted conversions and actual conversion data over time, in accordance with one or more aspects of the present disclosure.

FIG. 5B depicts an example signal and noise learning graph illustrating the separation of signal from noise in the machine learning analysis for broadcast attribution, in accordance with one or more aspects of the present disclosure.

FIG. 6A illustrates an example validation chart illustrating the difference between exposed and unexposed markets in time periods before, during, and after the implementation of a broadcast media promotional cycle, in accordance with one or more aspects of the present disclosure.

FIG. 6B depicts a market conversion comparison chart illustrating the within-market comparison of conversion performance before and during the broadcast media promotional cycle, in accordance with one or more aspects of the present disclosure.

FIG. 7A depicts a channel performance interface for displaying broadcast attribution data to a user, in accordance with one or more aspects of the present disclosure.

FIG. 7B depicts a broadcast attribution dashboard displaying an overview of performance metrics for a broadcast media promotional cycle, in accordance with one or more aspects of the present disclosure.

FIG. 8 depicts a block diagram of an example computing system operating in accordance with one or more aspects of the present disclosure.

### DETAILED DESCRIPTION

Embodiments are described for determining attribution and incrementality for broadcast media. As business has become increasingly digital, with consumers buying online, registering online, downloading apps, and more, businesses can track many key performance indicators (KPIs) that are digital in nature. Because digital advertising can reach specific audiences, the digital KPIs can make it relatively easy to draw the link between digital advertising exposure and subsequent conversion events (e.g., online purchases and other relevant behaviors). The link between digital advertising exposure and subsequent conversion events can provide a relatively straightforward way to determine attribution count for digital advertisements. Broadcast media, on the other hand, may reach a wide demographic and may not correspond to a person-level measurement of the advertisement exposure to connect with the digital conversion event. Broadcast media is not as personally traceable to digital conversion events as compared to digital advertising. Unlike addressable digital media, broadcast radio, television, and satellite advertising can lack person-level exposure measurement, making it difficult to connect broadcast media exposure to digital conversion behaviors observed at the individual level. Existing approaches to measuring broadcast advertising effectiveness have relied on simplistic models derived from direct response radio and television, such as counting conversions that occur within a short time window (e.g., fifteen minutes) after an advertisement airs. These simplistic approaches can be inaccurate because they may miss conversions from consumers who take longer to convert, such as those who hear a broadcast radio advertisement during a commute but do not act until later. At the same time, these approaches may overcount by attributing all conversions within the time window to the broadcast advertisement, even though many different factors could be influencing conversions at any given moment. Because broadcast advertising has not been measured on a level playing field with digital advertising, advertisers lack a consistent measurement framework to accurately compare the effectiveness of broadcast media promotional cycles with digital promotional cycles. This inconsistency can lead to suboptimal allocation of advertising resources and increased consumption of computing resources used to analyze and implement promotional cycles across both broadcast and digital channels.

Aspects of the present disclosure address the above-noted and other deficiencies by providing a system and method to determine broadcast attribution and incrementality for broadcast media promotional cycles that lead to conversion events. The broadcast attribution measurement techniques described herein provide a broadcast attribution count that is proportionate to digital attribution. The resulting broadcast attribution measurement described herein can be compared side-by-side with attribution measurements for digital promotional cycles (e.g., attribution measurements for digital promotions) in an accurate and meaningful manner. That is, the broadcast attribution measurement described herein provides an accurate reflection of an attribution count for a broadcast promotional cycle, and thus can be accurately and meaningfully compared to a digital attribution count for a digital promotional cycle that corresponds to the broadcast promotional cycle (e.g., that has a similar marketing objective). The broadcast attribution measurement techniques described herein provide a consistent measurement framework aligned with digital attribution methodologies, thus providing the same type of attribution counting and incrementality for both digital and broadcast media.

A broadcast media promotional cycle can refer to a coordinated series of broadcast media advertisements or promotional events designed to achieve a specific marketing objective, such as increasing brand awareness, promoting a product or service, or driving consumer engagement. A promotional event can include, for example, a live-read sponsorship by a popular radio disk jockey promoting a brand, a sponsored segment within a radio or television program, an endorsement by a program host, a contest or giveaway announced during a broadcast, or other sponsored content designed to promote a product, service, or brand to the broadcast audience. A promotional event can also be referred to as an advertisement, commercial, or spot. The series of broadcast media advertisements or promotional events can include, for example, radio advertisements, television advertisements, sponsorship of a program or event (e.g., a live-read sponsorship by a popular radio disk jockey promoting a brand), etc. A conversion event can be a specific action taken by a consumer that aligns with the goals of the broadcast media promotional cycle. A conversion event can be digital in nature. Examples of a conversion event can be making a purchase (e.g., online), filing out a contact form, subscribing to a newsletter, downloading an application (e.g., on a smartphone), content engagement (e.g., watching a video, clicking a link, downloading a resource, such as an e-book), spending a certain amount of time on a webpage, completing a survey, signing up for a webinar, event, or a free trial, and so on. In some embodiments, digital conversion events can correspond to individual consumers or groups of consumers, determined using cookies, device identifier, IP addresses, etc. In some embodiments, consumers provide consent to tracking technologies (e.g., by opting in to cookies or privacy settings), and/or can opt-out of tracking technologies. In some embodiments, tracking data is anonymized to protect personal identities.

Attribution can refer to the opportunity of a promotional message (or set of promotional messages) to influence a conversion event. Attribution can show the touchpoints at which a consumer has been exposed to a promotional message (or messages) and subsequently converted. Incrementality can refer to the increase in a conversion rate attributable to the promotional message(s). Incrementality can represent the subset of the attributable conversions that were caused by the advertising. The incrementality can be used to improve the performance of the promotional cycle. For example, the incrementality can be used to determine return on investment spend, return on investment, and/or to identify a time of day, genre, station, format, version, etc., of the promotional message that is most effective.

In some embodiments, aspects of the present disclosure provide a broadcast attribution and incrementality component that can determine attribution and incrementality for broadcast media promotional cycles that lead to digital conversion events. In some embodiments, determining broadcast attribution can include determining a baseline attribution using a rolling reach and adding an incrementality to determine an attribution count that can be accurately compared to a digital attribution count. In some embodiments, to determine the baseline attribution, the broadcast attribution and incrementality component can determine a reach or a rolling reach. The reach measurement for broadcast promotional cycles can refer to the total number of unique individuals (or households) exposed to a broadcast promotional message or broadcast promotional cycle within a specific time period, usually within a particular geographic area or region. The rolling reach can refer to the cumulative number of unique individuals (or households) exposed to a broadcast promotional message or broadcast promotional cycle over a moving time period, usually within a particular geographic area or region. The time period can reflect a lookback window, e.g., a period of time preceding a particular event, such as a conversion event. The lookback window can be, for example, seven days, two weeks, one month, etc. In some embodiments, the lookback window can correspond to a predetermined portion (e.g., 10%) of the duration of the promotional cycle. That is, if the planned duration of the promotional cycle is three months, the lookback window can be a portion of the three months. The broadcast attribution and incrementality can apply a random duplication to the rolling reach to determine the baseline attribution for the promotional cycle.

As used herein, “reach” can refer to the percentage or number of unique individuals within a geographic region (e.g., a designated market area) who are exposed to a broadcast promotional message at least once during a specific time period. The reach can be calculated by dividing the average number of people listening to or viewing a channel at the time a promotional message aired by the total population of the geographic region. For example, if a promotional message airs on a radio station at a time when an average of 50,000 people are listening, and the population of the designated market area is 500,000, the reach for that single airing would be 10 percent (50,000 divided by 500,000). The reach measurement can provide a baseline indication of the opportunity for a broadcast promotional message to influence consumers within the geographic region, in embodiments.

As used herein, “rolling reach” can refer to the cumulative percentage or number of unique individuals within a geographic region who are exposed to a broadcast promotional message at least once over a moving time period (e.g., a seven-day lookback window). The rolling reach can account for the accumulation of incremental reach as additional broadcast promotional messages air over time. For each subsequent airing of a promotional message, a portion of the audience may have already been reached by a previous airing (which increases the frequency of exposure), while another portion of the audience may be reached for the first time (which represents incremental reach). The rolling reach can be derived by analyzing the average listening or viewing patterns of different people over time to create a cumulative reach curve. For example, if a first airing of a promotional message reaches 10 percent of the population, a second airing may reach an additional 5 percent of the population who were not reached by the first airing, resulting in a rolling reach of 15 percent after two airings. As more promotional messages air, the incremental gain in reach typically decreases due to audience overlap, demonstrating diminishing returns, in embodiments.

In some embodiments, to determine the rolling reach, the broadcast attribution and incrementality component can identify an event log of broadcast promotional messages that ran during a lookback window (e.g., in a seven-day period) for a particular geographical area. In some embodiments, the lookback window can be a period of time (e.g., one day, seven days, one month, etc.) ending on the date on which a conversion event occurred. That is, the lookback window can include the period of time (e.g., 7 days) preceding the date on which the conversion event occurred. The geographical area can be a country or a part of a country, for example. The geographical area can include multiple regions. The regions can correspond to a designated market area (DMA), a zip code, a postal code, or any other geographical regional distinction. The event log can include event details (e.g., name of advertiser, the title of the advertisement or the name of the promotional campaign, the duration of the advertisement), air times (e.g., specific date and time the advertisement aired or is scheduled to air, the name of the program or show during which the advertisement ran or will run), channel on which the advertisement aired (or is scheduled to air), the region in which that channel is located (e.g., the DMA), placement (e.g., positioning within an advertisement break, priority level, or category), frequency (e.g., number of times the advertisement aired during a given time period), etc. In some embodiments, the event log can correspond to a spot log used by broadcasters and/or advertisers to track and manage the placement of commercials (sometimes called “spots”) during specific time slots.

In some embodiments, the broadcast attribution and incrementality component can apply a decay curve to model the diminishing impact of broadcast advertising over time following the initial airing of a promotional message. The decay curve can represent the decreasing probability that a broadcast advertisement will influence a conversion event as time passes from the initial exposure. In some embodiments, the decay curve can be applied within a lookback window (e.g., seven days or one month) to weight the impact of broadcast advertising impressions based on their recency relative to a conversion event.

In some embodiments, the broadcast attribution and incrementality component can observe that the longer-term effects of broadcast advertising can extend beyond the lookback window. For example, a broadcast advertisement may have a majority of its impact during the campaign and in the week immediately following the campaign, while a smaller incremental contribution can be observed for several weeks after the campaign ends. The lookback window can provide a way of defining what will be counted for attribution purposes, representing a conservative account that does not include longer-term effects. In some embodiments, the decay curve for broadcast advertising can be similar to the decay curve observed for digital advertising, providing a consistent methodology for calculating the reach of broadcast along with a decay of impact over the lookback window.

In some embodiments, the broadcast attribution and incrementality component can match conversions to impressions that occurred prior to the conversion using a lookback window decay model. The lookback window decay model can weight impressions based on their temporal proximity to the conversion event, with more recent impressions receiving higher weight than older impressions within the lookback window. This approach can be more consistent with how digital advertising is attributed and counted, enabling a more rigorous methodology that accounts for the diminishing influence of advertising exposure over time.

In some embodiments, the broadcast attribution and incrementality component can identify a conversion event. The conversion event can be associated with a consumer through, for example, a device identifier, an IP addresses, a login username and password combination, and so on. Using the event log, the broadcast attribution and incrementality component can determine whether the consumer is associated with (e.g., located in) one of the regions in which the broadcast media promotional cycle ran. If so, the broadcast attribution and incrementality component can determine the attribution and incrementality for that region.

In some embodiments, the broadcast attribution and incrementality component can determine the reach of one or more promotional message(s) of the broadcast media promotional cycle for the region for the period of time (e.g., a seven-day lookback window). The broadcast attribution and incrementality component can identify the number of advertisements that ran in the period of time related to the promotional message(s). For example, the broadcast attribution and incrementality component identify, using the event log, the number of times a particular promotional message (or set of messages) that corresponds to the conversion event aired during the lookback window. The broadcast attribution and incrementality component can identify the time at which the promotional message aired, and the average number of people listening to the channel (e.g., radio station, TV channel, etc.) on which the promotional message aired at that time. The reach can be the number of people listening to the channel at the time promotional message aired divided by the population of the region (e.g., DMA).

In some embodiments, the broadcast attribution and incrementality component can determine a rolling reach, e.g., an accumulation of incremental reach within a population. That is, for the second time the advertisement ran, there is a certain number of people who were already reached by the advertisement, which increases the frequency of the reach, and there is a certain number of people that are incremental, that were not reached by a previous airing of the promotional message. The incremental reach is based on the average listening patterns of people over time.

In some embodiments, the broadcast attribution and incrementality component can determine the cumulative reach curve (also referred to as a “reach cum curve”) by analyzing the average listening or viewing patterns of different people over time. The cumulative reach curve can represent the accumulation of incremental reach within a population as additional broadcast media promotional items air over a time period. To calculate the cumulative reach curve, the broadcast attribution and incrementality component can identify the number of spots (e.g., advertisements) running on one or more channels and relate the spots to a size of audience of people who listen to or view the channel. For each spot that airs, the broadcast attribution and incrementality component can calculate the time at which the spot ran and the average number of people listening to or viewing the channel at that time. The average number of people can be divided by the population of the geographic region (e.g., DMA) to determine a reach percentage for that spot.

In some embodiments, for each subsequent airing of a promotional message, the broadcast attribution and incrementality component can determine a number of people who were already reached by a previous airing (which increases the frequency) and a number of people that are incremental (that were not reached by a previous airing). The determination of incremental reach can be based on analyzing the average listening or viewing patterns of different people over different times. For example, some listeners may consistently listen to a radio station during morning commute hours, while other listeners may listen during evening hours. By analyzing these patterns, the broadcast attribution and incrementality component can estimate the overlap between audiences reached by different airings and the incremental audience reached by each subsequent airing.

In some embodiments, the cumulative reach curve can be visualized as a graph showing the relationship between the number of spots (on the horizontal axis) and the cumulative reach (on the vertical axis). The cumulative reach curve can demonstrate diminishing returns, where initial advertising spots contribute more significantly to reach, but as more spots are added, the incremental gain in reach decreases. This occurs because as more spots air, a greater proportion of the audience has already been reached by previous airings, and fewer new individuals are being reached for the first time. The cumulative reach curve can provide a baseline number representing the average amount of people during the lookback window that would have been reached by a broadcast advertisement at least once. This baseline number can serve as the starting place for the attribution calculation.

In some embodiments, the broadcast attribution and incrementality component can determine the baseline attribution by multiplying the reach (or the rolling reach) by the total number of conversion events in the geographical region during the period of time (e.g., the lookback window). In some embodiments, the broadcast attribution and incrementality component can use the event log to determine the total number conversion events in the geographical region during the period time. In some embodiments, the baseline attribution can correspond to a random duplication measurement.

In some embodiments, the broadcast attribution and incrementality component can determine the incrementality for the broadcast media promotional cycle. In some embodiments, the incrementality can represent a subset of the attributable conversions that were caused by the promotional message. To calculate the incrementality, the broadcast attribution and incrementality component can use machine learning analysis, shuffle sampling, and/or counterfactual analysis to determine the incrementality. The incrementality can represent the count of conversions above the baseline. In some embodiments, the broadcast attribution and incrementality component can determine the incrementality using machine learning analysis, shuffle sampling, and/or counterfactual analysis.

In some embodiments, the broadcast attribution and incrementality component can train and/or implement an artificial intelligence (AI) model to predict a number of conversion events for a given promotional cycle. In some embodiments, the AI model can be trained to receive, as input, an event log of broadcast promotional messages that ran in a particular geographical area. In some embodiments, the input can also include a time series data. The time series data can include data points representing the number of conversions at sequential time intervals. The time series data can provide insights into trends, patterns, and/or fluctuations of the conversions over a particular time period. The particular time period can be the lookback window, for example. In some embodiments, the particular time period can be a longer period of time, that optionally includes the lookback window. In some embodiments, the AI model can be trained to provide, as output, a predicted conversions for the promotional messages.

In some embodiments, the broadcast attribution and incrementality component can run the AI model twice. The first time, the broadcast attribution and incrementality component can provide as input the event log, and optionally the time series data. The second time, the broadcast attribution and incrementality component can provide as input a subset of the event log, and optionally the time series data. The subset can be the event log without the promotion placement information. Thus, the first output (corresponding to the first input) can represent the predicted conversions for the geographical area having received the promotional messages, and the second output (corresponding to the second input) can represent the predicted conversions for the geographical area having not receive the promotional messages. The difference between the two outputs represents the incrementality, or the incremental conversions attributable to the promotional messages airing in the geographical area.

In some embodiments, the broadcast attribution and incrementality component can use shuffle sampling as a validation technique. The shuffle sampling can analyze a region with varying degrees of exposure to the broadcast media promotional cycle to neutralize false-positive signals. In some embodiments, the broadcast attribution and incrementality component can use counterfactual analysis to isolate the impact of a broadcast media promotional cycle by testing regions that were not provided the broadcast media promotional cycle as a baseline.

In some embodiments, the incrementality can be added to the random duplication of conversions (e.g., the baseline attribution) to determine the attribution measurement for the broadcast media promotional cycle. That is, the attributed impressions is the random duplication of conversions based on reach plus the incremental conversions, in some embodiments.

In some embodiments, the broadcast attribution and incrementality component can use the incremental conversions attributable the promotional messages airing in the geographical area to determine to calculate return on advertisement spend (ROAS) and/or return on investment (ROI). In some embodiments, the broadcast attribution and incrementality component can use the attribution and/or incrementality measurement(s) to determine top performing parameters for the broadcast media promotional messages. The parameters can include, for example, the time of day that the message(s) air, the type of genre of the channel on which the message(s) air, the station on which the message(s) air, the format of the message(s), the template of the message(s), etc. The top performing parameters can be those that correspond with an incrementality and/or lift value that exceeds a threshold. In some embodiments, the top performing parameters can be those that exceed a threshold value. In some embodiments, the top performing parameters can be the type x performers, where x is an integer or a percentage (e.g., the promotional message(s) that have an incrementality and/or lift in the top 10% can be identified as top performers).

In some embodiments, the broadcast attribution and incrementality component can provide the attribution and/or incrementality of the promotional messages in the broadcast promotional broadcast cycle to a user device. In some embodiments, the broadcast attribution and incrementality component can use the attribution and/or incrementality to determine an action to perform with respect to the broadcast promotional broadcast cycle. For example, the broadcast attribution and incrementality component can generate an instruction to modify scheduled airing of a particular promotional message according to the top performing parameters.

Aspects of the present disclosure provide technical advantages including reduced usage of computing resources used for analyzing and implementing broadcast media promotional cycles. That is, by accurately measuring the attribution of broadcast media promotional cycles, aspects of the present disclosure can result in reduced computing resources (e.g., processing resources, bandwidth, and so on) used in analyzing and implementing broadcast media promotional cycles. For example, the computing resources used in analyzing the effectiveness of a broadcast media promotional cycle can be reduced using the techniques described throughout. Additionally, the broadcast attribution described throughout can be accurately and meaningfully compared digital attribution measurements, which can lead to a reduction in computing resources used to implement both digital and/or broadcast media promotional cycles. That is, by comparing like measurements (broadcast attribution, as described throughout, and digital attribution), aspects of the present disclosure can reduce the consumption of resources not only in the determination and analysis of the attribution, but also in the implementation of the promotional cycles themselves. For example, an attribution measurement for a particular broadcast promotional cycle that is greater than the attribution for a corresponding a digital promotional cycle can result in an adjusted implementation of either the broadcast and/or the digital promotional cycle (e.g., by removing the unsuccessful or less successful digital promotions), thus avoiding utilizing computing resources to air unsuccessful or less successful promotions.

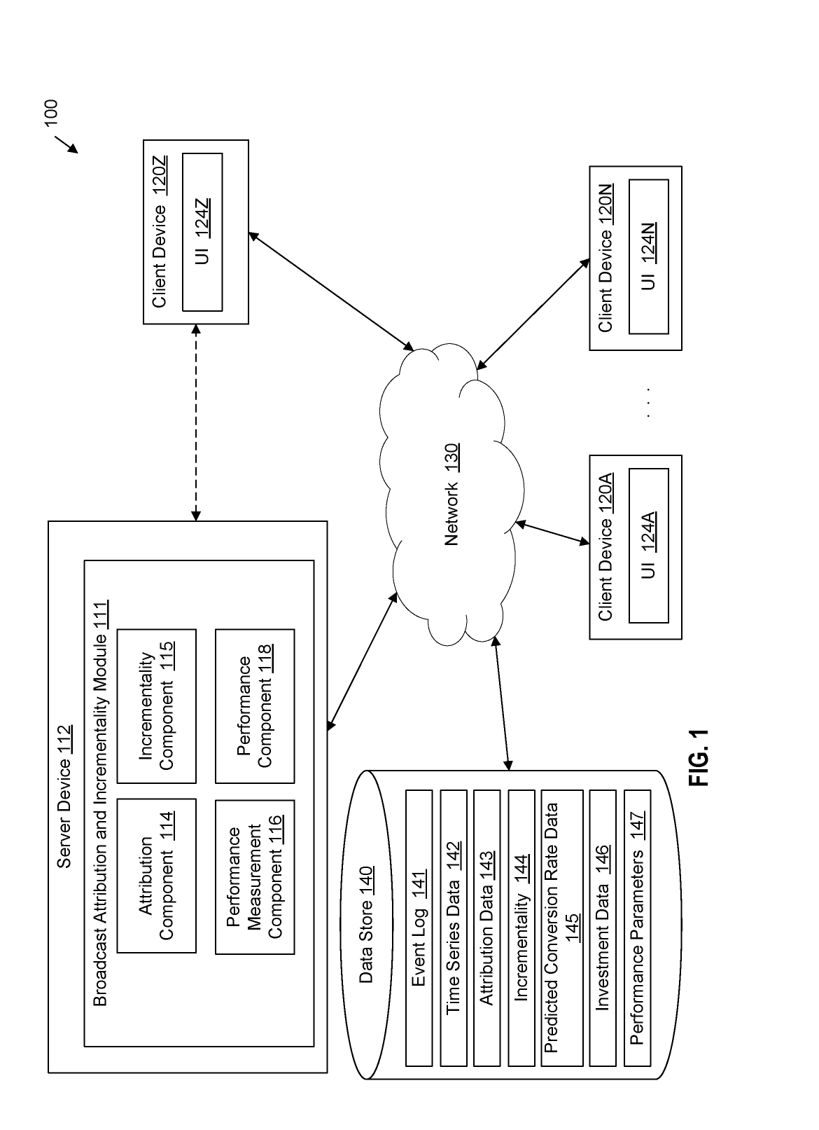

FIG. 1 illustrates an example of a system architecture 100 for implementations of the present disclosure. The system architecture 100 includes a server device 112, a data store 140, and/or client devices 120A-Z connected via a network 130. The network 130 may be one or more public networks (e.g., the Internet), private networks (e.g., a local area network (LAN) or wide area network (WAN)), or a combination thereof. The network 130 may include a wireless infrastructure, which may be provided by one or more wireless communications systems, such as Wi-Fi hotspot connected with the network 130 and/or a wireless carrier system that can be implemented using various data processing equipment, communication towers, etc. Additionally or alternatively, the network 130 may include a wired infrastructure (e.g., Ethernet). In some embodiments, the network 130 can be a single network.

In some embodiments, data store 140 can be a persistent storage that is capable of storing an event log 141, time series data 142, attribution measurements 143, incrementality measurements 144, predicted conversion rates 145, investment statistics 146, and/or performance parameters 147. Data store 140 may be hosted by one or more storage devices, such as main memory, magnetic or optical storage based disks, tapes or hard drives, NAS, SAN, and so forth. In some implementations, data store 140 may be a network-attached file server, while in other embodiments data store 140 may be some other type of persistent storage such as an object-oriented database, a relational database, and so forth, that may be hosted by server device(s) 112, and/or client device(s) 120A-Z. In some embodiments, data store 140 may be hosted by or one or more different machines coupled to the server device 112, and/or user device 120A-Z.

In some embodiments, the event log 141 can include data that corresponds to a record or schedule to track and/or manage the placement of promotional messages during specific time slots on a number of broadcast and/or digital platforms. In some embodiments, the event log 141 can include placement data, region data, and/or date data. In some embodiments, the placement data can be grouped by region and date. The region data can correspond to geographical regions, such as designated market areas (DMAs), zip code, county, city, etc. The date data can correspond to the dates covered by the event log 141, and/or the dates of a particular lookback window. The date data can include, for example, day of the week and/or day number as an increasing sequence. In some embodiments, the promotion placement data can include channel, broadcast hour, broadcast day of the week, and/or the length of the promotional message.

In some embodiments, the event log 141 can correspond to a spot log used by broadcasters and/or advertisers to track and manage the placement of promotional messages (sometimes called “spots”) during specific time slots. The event log 141 can include event details such as the name of the advertiser, the title of the advertisement or the name of the promotional campaign, and/or the duration of the promotional message. The event log 141 can also include air times, such as the specific date and time the promotional message aired or is scheduled to air, and the name of the program or show during which the promotional message ran or will run. In some embodiments, the event log 141 can include the channel on which the promotional message aired or is scheduled to air, and the region in which that channel is located (e.g., the DMA). The event log 141 can further include placement information, such as the positioning within an advertisement break, priority level, and/or category. In some embodiments, the event log 141 can include frequency information indicating the number of times the advertisement aired during a given time period.

In some embodiments, the event log 141 can include flight dates observed based on a log file or media monitor file. The flight dates can correspond to the dates during which a broadcast media promotional cycle was active. In some embodiments, the event log 141 can include impression data, wherein placements are grouped by date and region (e.g., down to the DMA level). The event log 141 can also include pixel data representing conversions grouped by date and region, which can be matched to impressions that occurred prior to the conversion using a lookback window decay model.

In some embodiments, the event log 141 (or a portion of the event log 141) can correspond to broadcast media promotional cycle. As described herein, a broadcast media promotional cycle can refer to a coordinated series of broadcast media advertisements or promotional events designed to achieve a specific marketing objective, such as increasing brand awareness, promoting a product or service, or driving consumer engagement. The series of broadcast media advertisements or promotional events can include, for example, radio advertisements, television advertisements, satellite radio advertisements, sponsorship of a program or event, or other broadcast promotional content.

In some embodiments, the broadcast media promotional cycle can include satellite radio (or satellite audio) advertising. Satellite radio advertising can be delivered nationally, and thus event log 141 can include a subscriber file, a listener survey, or both. A subscriber file can include data indicating the geographic distribution of satellite radio subscribers across different regions (e.g., DMAs). For example, the subscriber file can indicate that some DMAs have a higher percentage of subscribers (e.g., 30% more subscribers than average) while other DMAs have a lower percentage of subscribers (e.g., 30% fewer subscribers than average). This variation in subscriber density across regions can provide the heavier and lighter exposure data that the AI model uses to calculate advertising effectiveness.

In some embodiments, a listener survey can include data indicating the geographic location (e.g., zip code) of listeners and their listening preferences (e.g., preferred channels, genres, or programs). For example, a listener survey can indicate that a particular listener located in a particular zip code listens to news programming, while another listener located in a different zip code listens to a particular music genre. The combination of the listener survey data with the event log data 141 indicating which channels or stations the advertisements ran on can create a regional profile of exposure. The regional profile can indicate heavier or lighter exposure to the broadcast media promotional items within different regions based on the listening preferences of consumers in those regions. In some embodiments, the regional profile can be used by the AI model to determine the varying volumes of advertising delivery across geographic regions for the cross-sectional regional analysis.

In some embodiments, the time series data 142 can include data points representing a number of conversions (and/or a conversion rate) at various points in time. The points in time can correspond to sequential time intervals, e.g., per hour, per day, per week, etc. In some embodiments, the points in time can corresponds to the date data of the event log. In some embodiments, the attribution measurement data 143 can include a reach and frequency of a broadcast media item that is part of a broadcast media promotional cycle. In some embodiments, the incrementality measurement data 144 of data store 140 can include the incremental lift (e.g., the increase in conversions (the number of conversions, or the conversion rate) that is attributable to the broadcast media of the broadcast media promotional cycle). In some embodiments, the predicted conversion rate data 145 of data store 140 can include the output of the AI model that is trained to predict conversions for promotional messages. In some embodiments, the investment statistics data 146 of data store 140 can include the return on investment and/or return on advertising spend corresponding to the predicted conversion rate(s). In some embodiments, the performance parameter data 147 of data store 140 can include the time of day that the message(s) air, the type of genre of the channel on which the message(s) air, the station on which the message(s) air, the format of the message(s), the template of the message(s) for the top performing promotional media items of the broadcast media promotional cycle.

The client devices 120A-Z may be represented by one or more physical machines (e.g., server machines, desktop computers, etc.) that include one or more processing devices communicatively coupled to memory devices and input/output (I/O) devices. In some embodiments, a client device 120A-Z can be used to perform a conversion event. In some embodiments, a client device 120A-Z can be used to air a promotional item of the broadcast media promotional cycle. In some embodiments, a client device 120A-Z can be used to implement a broadcast media promotional cycle (e.g., to schedule the airing of promotional items). In some embodiments, a client device 120A-Z can be used to display the results of a broadcast media promotional cycle (e.g., as determined by broadcast attribution and incrementality module 111).

The server device 112 may be represented by one or more physical machines (e.g., server machines, desktop computers, etc.) that include one or more processing devices communicatively coupled to memory devices and input/output (I/O) devices. In some embodiments, server device 112 can include a broadcast attribution and incrementality module 111. The broadcast attribution and incrementality module 111 can include an attribution component 114, an incrementality component 115, a performance measurement component 116, and/or a performance component 118. The functions of the components 114-118 can be combined into fewer components, and/or separated in additional components.

In some embodiments, the attribution component 114 can determine baseline attribution for a broadcast media promotional cycle. The baseline attribution can correspond to the reach and frequency of a broadcast media item (or items) of a broadcast media promotional cycle. The reach can be described as the number of people during a particular time period (e.g., a lookback window) that statistically would have been exposed to the broadcast advertisement at least once. In some embodiments, the attribution component 114 can identify, e.g., using the event log, the number of promotions (e.g., spots) airing per station per daypart within a region (e.g., DMA) and estimate the duplication among the audience to produce a reach estimate. The attribution component 114 can use a random duplication model to estimate the reach in some embodiments.

In some embodiments, a conversion event can be identified using the event log data, which records the region (e.g., DMA) where the conversion event occurred. For example, the conversion event may be an online purchase, and the attribution component 114 can use the IP address of the device on which the purchase was made to identify the region associated with the conversion event. The attribution component 114 can identify, using the event log, a broadcast media promotional cycle that is associated with the conversion, that aired in the identified region. The attribution component 114 can use the promotion placement data from the event log to identify the time at which a promotional item of the broadcast media promotional cycle aired, and the channel on which the promotional item ran. The attribution component 114 can also identify the average number of people listening that channel at that time, and can divide the average number of people by the population of the region. In some embodiments, the broadcast attribution and incrementality module 111 can have access to audience measurement surveys or logs, e.g., generated by specialized research firms, that include the average number of people listening to particular channels at particular times. The average number of people listening to a channel on which a promotional media item of the broadcast media promotional cycle corresponding to a conversion event, divided by the population of the region associated with the conversion event, represents the reach. For each subsequent airing of the promotional media item, there can be a certain number of people who were already reached and a certain number of people who were not reached. The attribution component 114 can analyze the average listening patterns of different people over time to create a cumulative curve, representing the accumulation of incremental reach within a population. The cumulative curve can represent the frequency. In some embodiments, the reach and/or frequency can be identified from a report provided by a broadcast media provider or agency, for example.

In some embodiments, the attribution component 114 can apply a decay curve when calculating the baseline attribution for a broadcast media promotional cycle. The decay curve can model the diminishing probability that a broadcast advertisement will influence a conversion event as time passes from the initial exposure. The attribution component 114 can weight broadcast advertising impressions based on their recency relative to a conversion event, with more recent impressions receiving higher weight than older impressions within the lookback window. This weighting can be applied when matching conversions to impressions that occurred prior to the conversion, enabling the attribution component 114 to account for the temporal relationship between advertising exposure and consumer behavior.

In some embodiments, the lookback window decay model can define a mathematical function representing the decay of advertising impact over time. The decay function can be an exponential decay, a linear decay, or another suitable function that models the diminishing influence of advertising exposure. For example, an exponential decay function can assign a weight of 1.0 to an impression occurring on the same day as the conversion, a weight of approximately 0.5 to an impression occurring three days before the conversion, and progressively smaller weights to impressions occurring further in the past. The specific parameters of the decay function can be configured based on the characteristics of the broadcast media promotional cycle, the type of conversion event, or historical data indicating the typical time between advertising exposure and conversion. In some embodiments, the decay function parameters can be learned or optimized by the AI model based on observed conversion patterns.

In some embodiments, the incrementality component 115 can determine the incrementality, or the count of conversions above the baseline attribution (e.g., as determined by attribution component 114), for a broadcast media promotional cycle. That is, in some embodiments, the incrementality component 115 can determine the increase in conversions (the number of conversions, or the conversion rate) that is attributable to the broadcast media of the broadcast media promotional cycle. The incrementality component 115 can measure the statistical relationship between the delivery of broadcast promotional messages (e.g., the attribution) and the KPI events (e.g., conversion events). The statistical relationship can show how the broadcast media promotional cycle influences consumer behavior. The relationship can be based, at least in part, on a time series model that represents, for example, the most recent event log including impressions and the conversions occurring within a particular lookback period during the broadcast media promotional cycle. To address the challenge of multicollinearity, the incrementality component 115 can include a cross-sectional regional analysis to complement the time series. Multicollinearity can refer to multiple factors simultaneously influencing a KPI (e.g., a conversion event). For example, an online store may promote gifts for the holiday season. The KPIs may be website visits and online purchases. Broadcast advertising may begin at the same time that consumers being to shop for holiday gifts, and thus the time series corresponding to the conversions may not accurately identify how much of the website visits and sales are due to the broadcast advertising. Another example of multicollinearity is when a broadcast advertising campaign coincides with the launch of a new product. Multicollinearity can lead to one media getting credit for another media’s contribution.

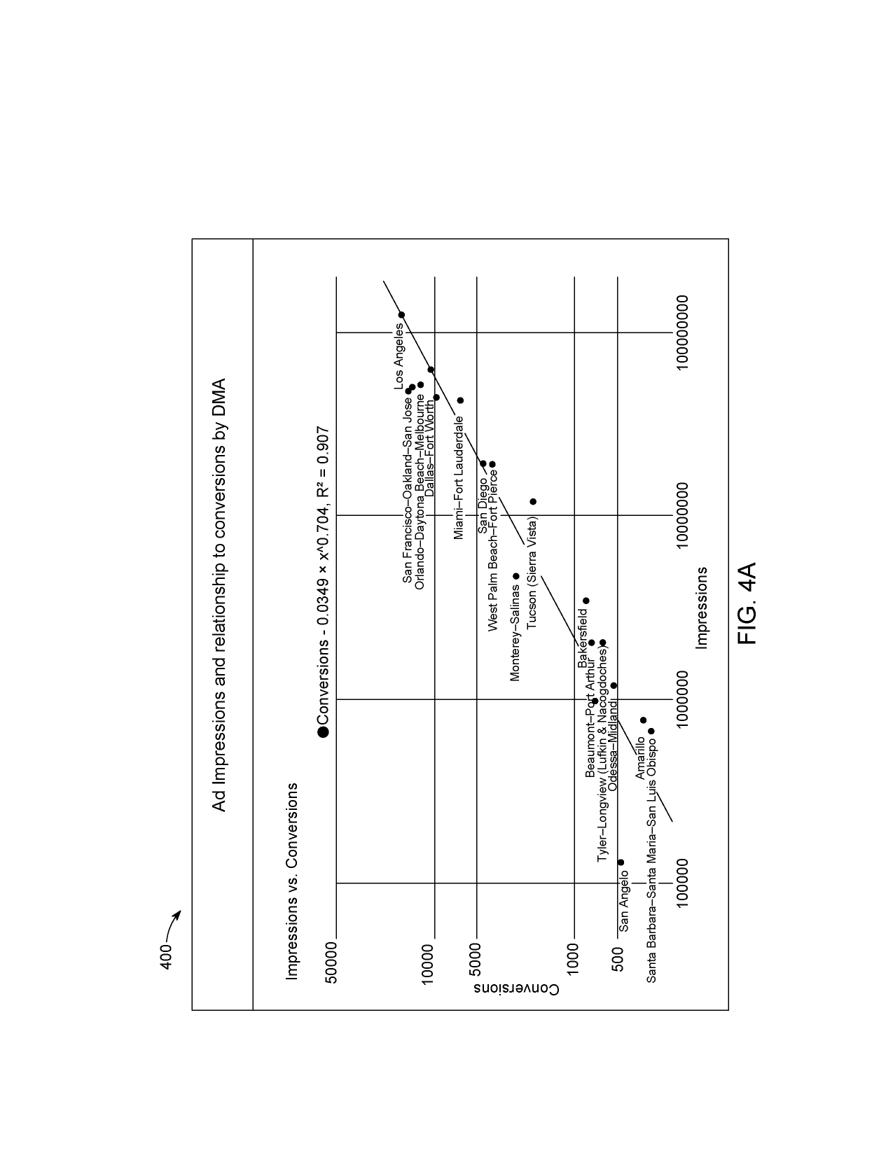

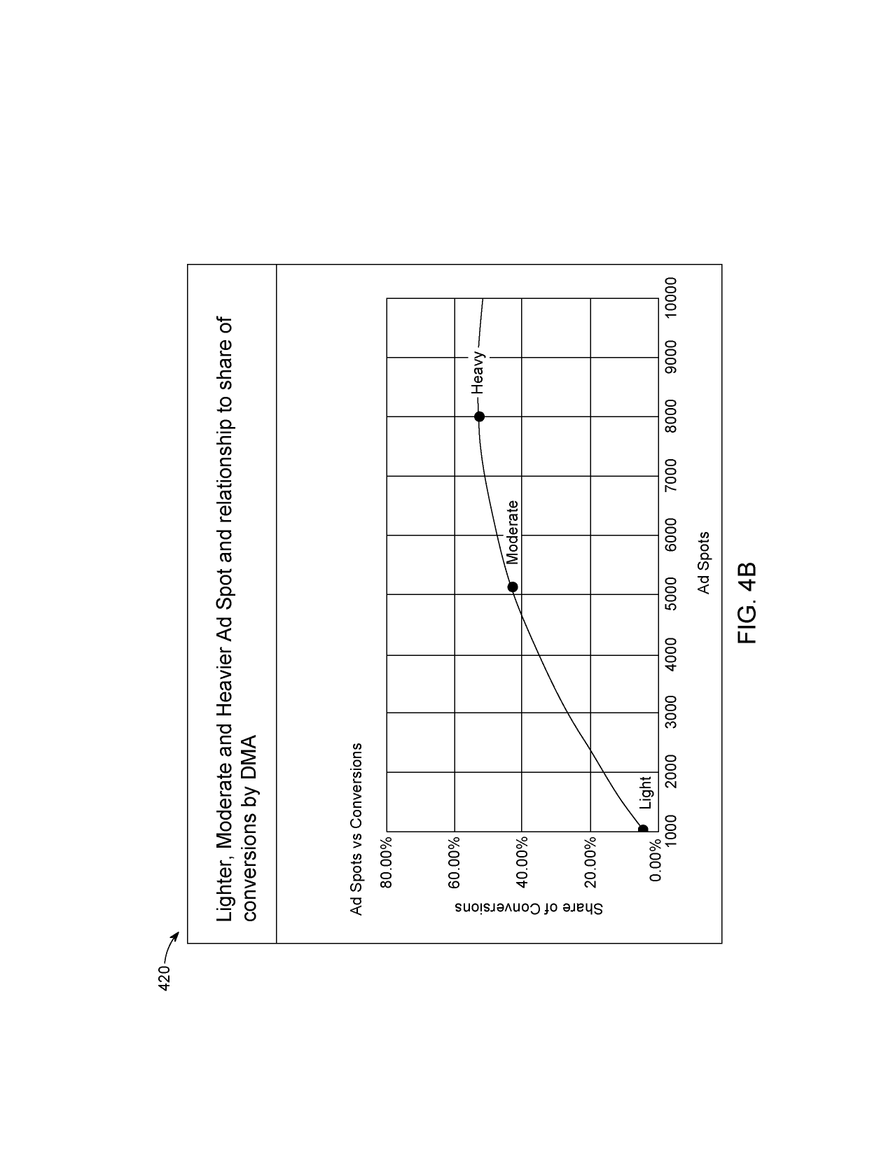

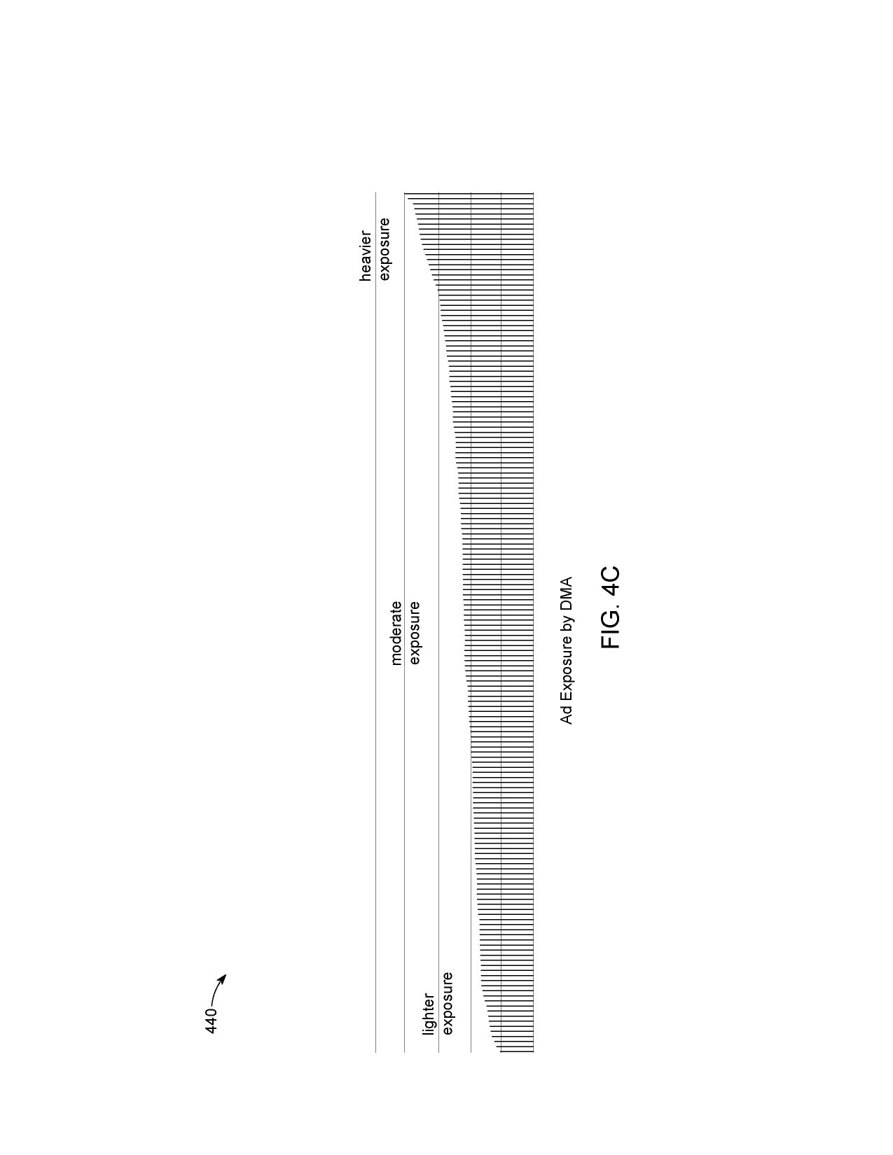

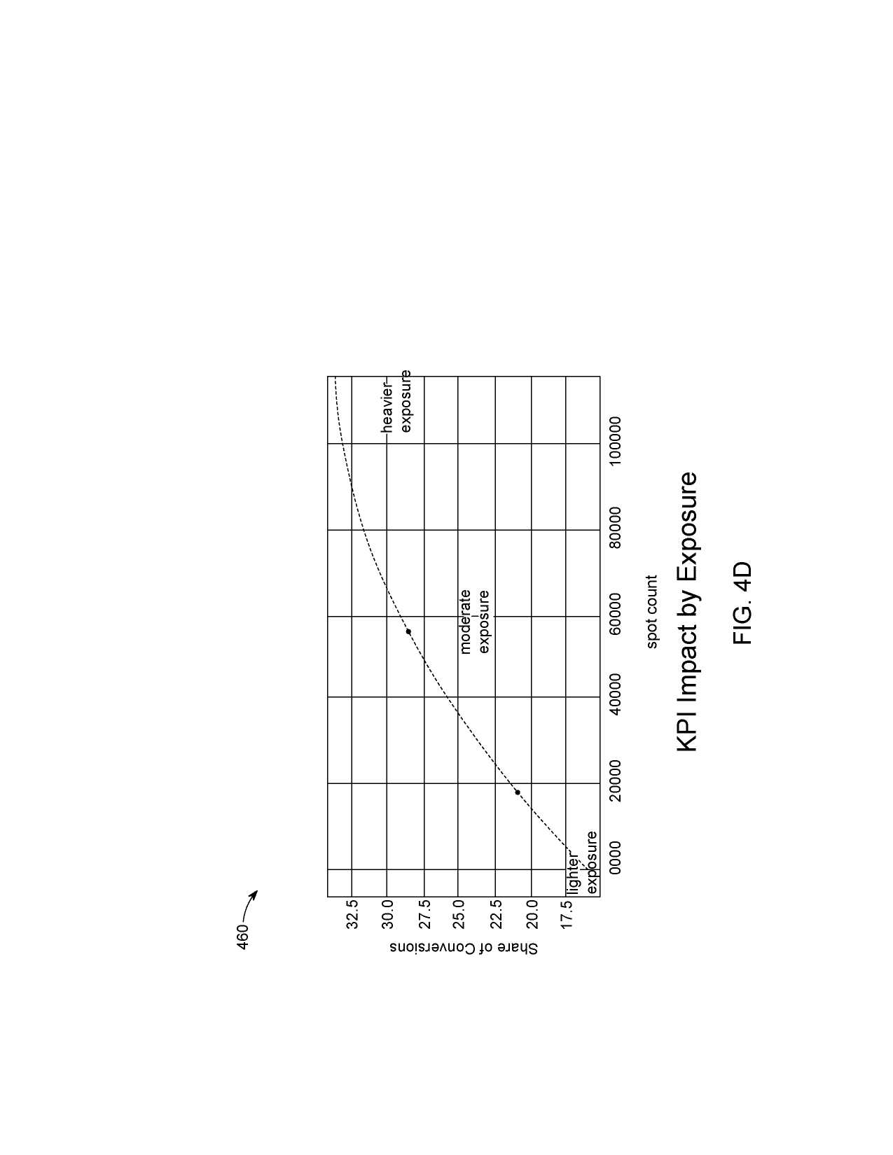

In some embodiments, to address the challenge of multicollinearity, the incrementality component 115 can use regional data on advertising volume (e.g., reach and frequency, and/or total impressions and number of advertisements aired). The incrementality component 115 can perform a comparison of regions (e.g., DMAs, state, counties, zip codes, etc.) where there is a range of volume of advertising delivered to the consumers. In some embodiments, the range can include high, moderate, and low. For example, spot count (e.g., the number of advertisements that ran in a particular time period) can be used to observe the relationship to the KPI (e.g., conversion event) within a time interval. FIG. 4A depicts a graph 400 illustrating an example of the relationship between impressions and conversion by region (e.g., DMA), in accordance with one or more aspects of the present disclosure. FIG. 4B depicts a graph 420 illustrating an example simplified version of relationship between impressions and conversion by region, in which the regions (e.g., DMAs) are grouped into exposure terciles, including light, moderate, and heavy exposure, to show the relationship between advertising exposure to conversions, in accordance with one or more aspects of the present disclosure. FIG. 4C depicts a graph 440 illustrating an example of promotion exposure by region (e.g., DMA), in accordance with one or more aspects of the present disclosure. The graph 440 depicts the regions with lighter exposure, moderate exposure, and heavier exposure. The light, moderate, and heavy categories can correspond to those illustrated in FIGS. 4B and 4D. FIG. 4D depicts a graph 460 illustrating the KPI impact by exposure, in accordance with one or more aspects of the present disclosure. As illustrated in FIG. 4D, the x-axis can represent the “spot count,” or the number of promotion exposures, and the y-axis can represent the conversions. The graph 460 includes lighter, moderate, and heavier exposure labels, which can correspond to the light, moderate, and heavy labels of FIGS. 4B-C. In some embodiments, graphs 400, 420, 440, and/or 460 can be used to determine the causal relationship between exposure to promotional broadcast media items and conversion events. In some embodiments, graphs 400, 420, 440, and/or 460 can combine the attribution of both digital and broadcast media promotional items in terms of the path to purchase to represent the incremental contribution, in accordance with aspects of the present disclosure.

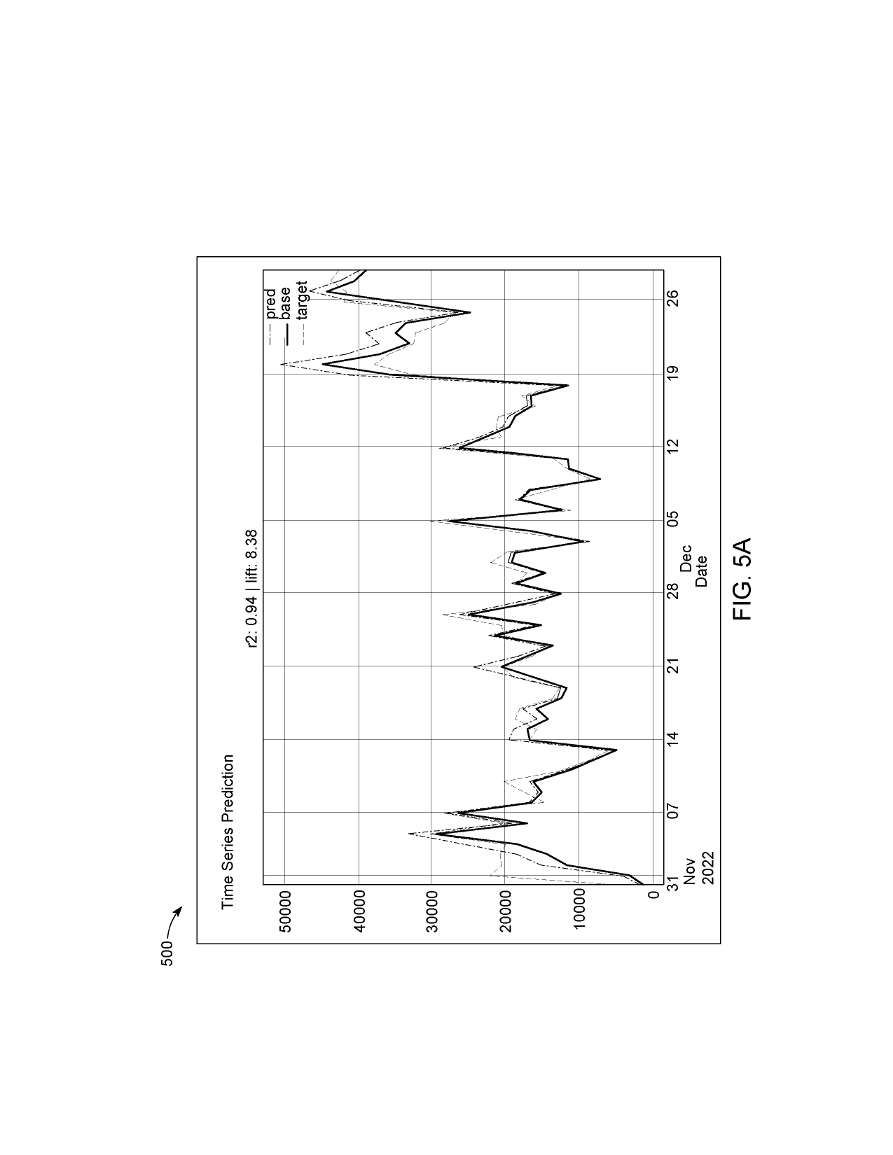

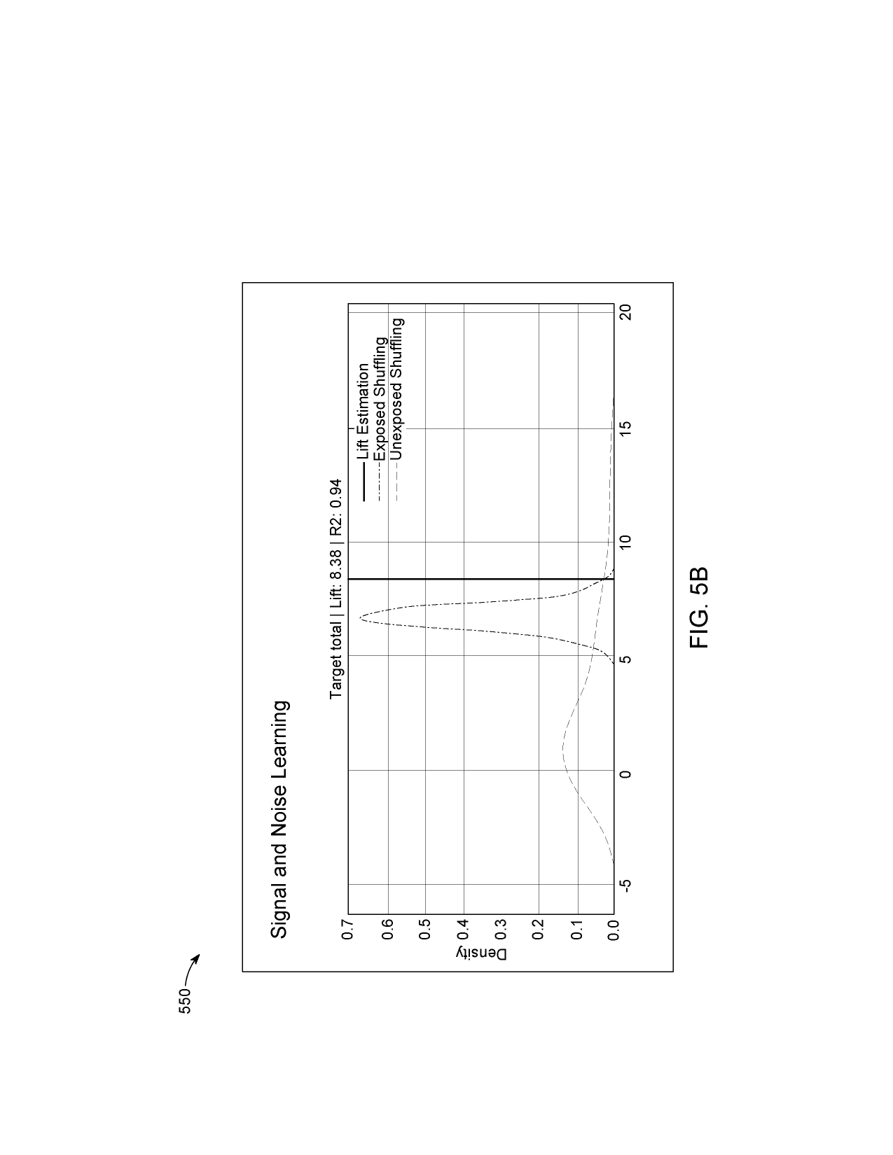

In some embodiments, the incrementality component 115 can include and/or implement a trained AI model that implements machine learning (ML), shuffle sampling, and/or optionally counterfactual analysis, to evaluate the differences in conversions in relation to differences in advertising weight. In some embodiments, the AI model can be or include a linear regression model, a neural network, a decision tree, a support vector machine, a gradient boosting model, and/or other suitable model architectures configured to fit the input features to the conversion data and determine a best fit prediction of conversions. Shuffle sampling of different regions (e.g., DMAs) in different combinations can develop a highly reliable measure of the true impact of broadcast advertising. In some embodiments, the incrementality component 115 can use a counterfactual approach for local broadcast, where some regions receive broadcast advertising and others do not. To account for the effects of seasonality or multicollinearity, the ML model can adjust the impact of advertising until false positive signals are neutralized. Thus, the incrementality component 115 provides a more accurate measure of the true incremental contribution of a broadcast media to the KPI by controlling for multicollinearity. In some embodiments, the incrementality value determined by the incrementality component 115 can be added to the baseline attribution (e.g., the random duplication derived from the cumulative reach curve, as determined by the attribution component 114) to produce the total attribution measurement for the broadcast media promotional cycle. FIGS. 5A-B illustrate an example of the AI process, in accordance with one or more aspects of the present disclosure. FIG. 5A illustrates time series data 500 and a prediction of the conversion the AI would expect to occur, labeled “pred.” The AI can separate the initial estimate of base level impact (labeled “base”) form the impact of broadcast (labeled “target”). The ML uses the regional data (e.g., from FIGS. 4A or 4B) to refine its measure of attributed impact. Specifically, the ML separates signal from noise. FIG. 5B illustrates the signal and noise 550 of the exposed markets (labeled “exposed shuffling”) compared to the unexposed markets (labeled “unexposed shuffling”). The difference in density shows the degree to which the ML algorithm can separate the signal of broadcast advertising impact from the noise of seasonality, other advertising mediums, and/or other marketplace effects. The line labeled “lift estimation” in FIG. 5B illustrates the observed lift over baseline. The incrementality component 115 uses the lift to calculate the conversions attributed to broadcast. In some embodiments, the incrementality component 115 can use regional data to refine the measure of attributed impact by distinguishing between exposed and unexposed markets. This can help accurately separate the signal from the noise when determining attribution.

In some embodiments, the machine learning model can separate signal from noise by analyzing the distribution of conversions in exposed markets compared to unexposed markets. The AI model can begin with the time series data and generate a prediction of the conversions expected to occur (the “pred” value). The AI model can separate an initial estimate of base level impact (the “base” value) from the impact of broadcast advertising (the “target” value). The machine learning model can use the regional data to refine its measure of attributed impact by comparing the density of conversions in exposed markets versus unexposed markets. The difference in density can indicate the degree to which the machine learning algorithm is separating the signal of broadcast advertising impact from the noise of seasonality, other advertising mediums, and other marketplace effects. The observed lift over baseline can be used to calculate the conversions attributed to broadcast advertising.

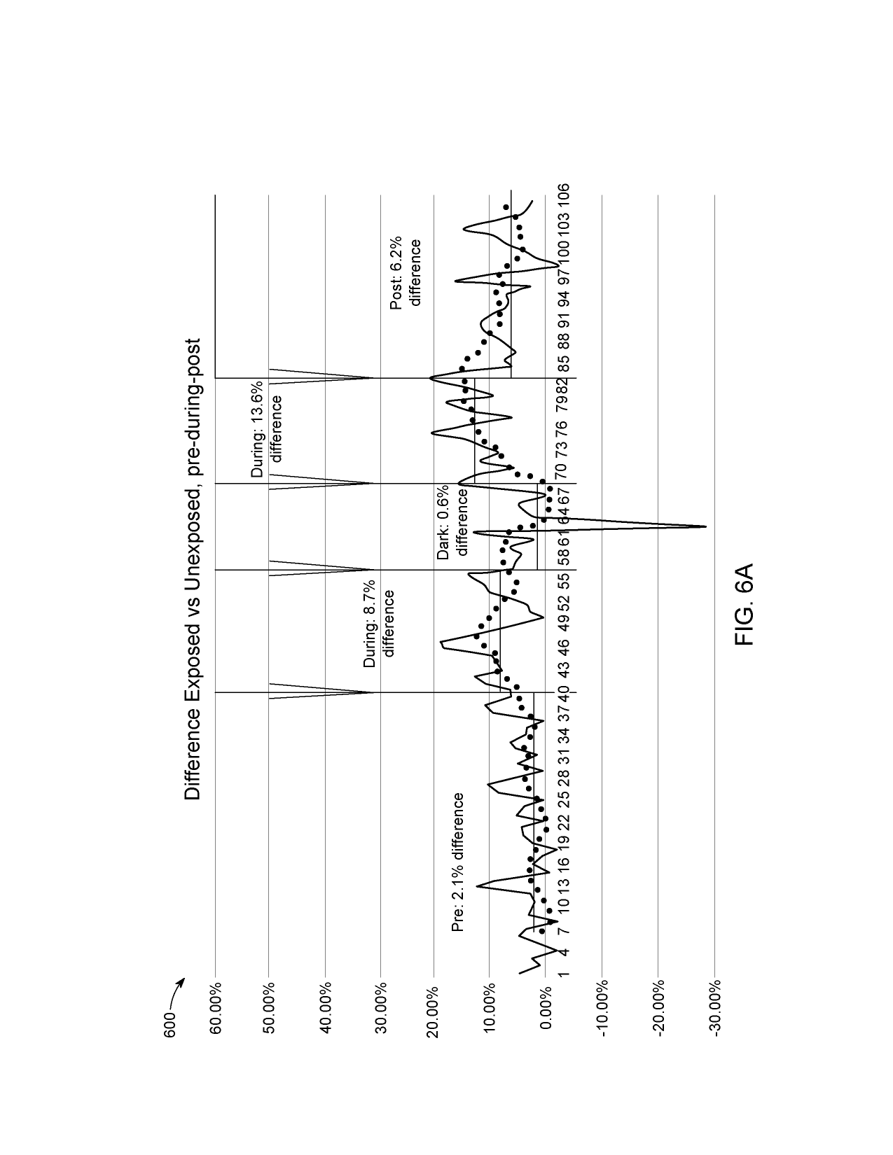

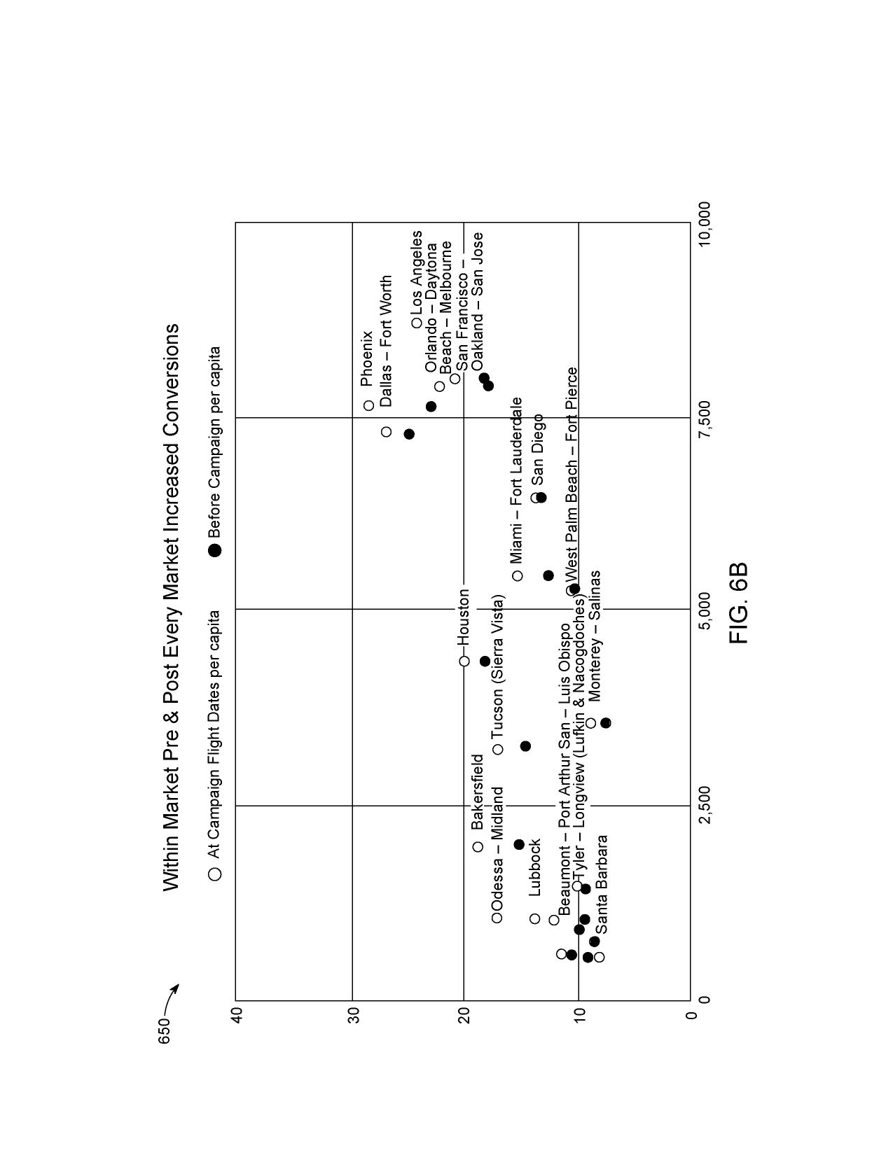

For example, FIG. 6A illustrates the difference between exposed and unexposed markets in time periods before the implementation of a broadcast media promotional cycle, during implementation of the broadcast media promotional cycle, and after the implementation of the broadcast media promotional cycle, in accordance with one or more aspects of the present disclosure. As illustrated in graph 600 of FIG. 6A, the attributed impact increased during the implementation of the broadcast media promotional cycle. The attributed impact of graph 600 can be applied to each region (e.g., DMA) to show that each region (e.g., DMA) increased conversions, as illustrated in graph 650 of FIG. 6B. Thus, FIG. 6B illustrates the increase in conversions attributable to the broadcast media promotional cycle, in accordance with one or more aspects of the present disclosure.

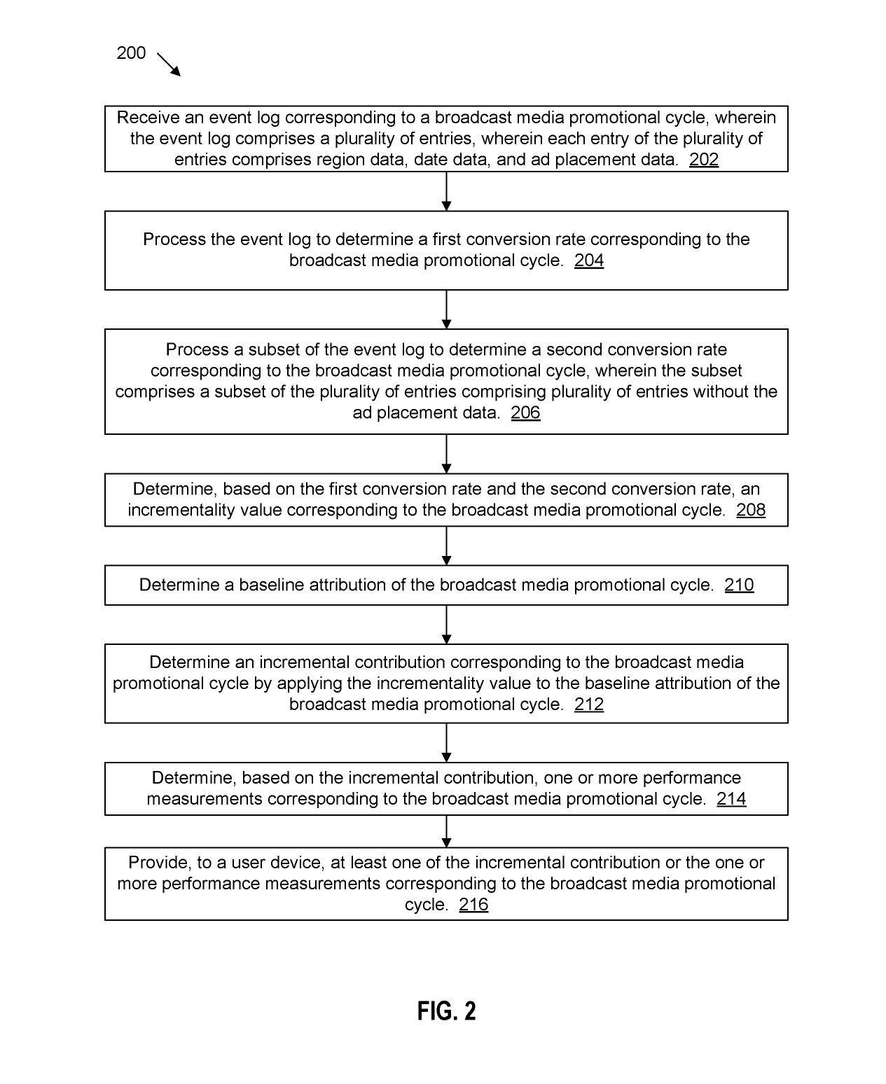

In some embodiments, the incrementality component 115 can, using the trained AI model, determine an attributed count of conversions due to a broadcast as a share of total conversions for each KPI and overall. The incrementality determination is further described with respect to FIG. 2. In some embodiments, the incrementality component 115 can add the random duplication (e.g., the baseline attribution as determined by attribution component 114) to the incrementality (e.g., as determined using the AI model) to determine the attribution, or the attributed count of conversions.

In some embodiments, the AI model used by the incrementality component 115 can include or implement a linear regression model. The linear regression model can be configured to fit the input features to the conversion data to determine a best fit prediction of conversions. The linear regression model can use standard metrics such as R-squared (R²) and mean squared error to evaluate the quality of the fit. In some embodiments, the linear regression model can achieve a median R² of 0.95 or higher, indicating a high level of confidence that the model accurately attributes the impact of broadcast advertising to digital KPIs. The R² value can range from approximately 0.80 to 0.98 across different campaigns, with higher values indicating better model fit.

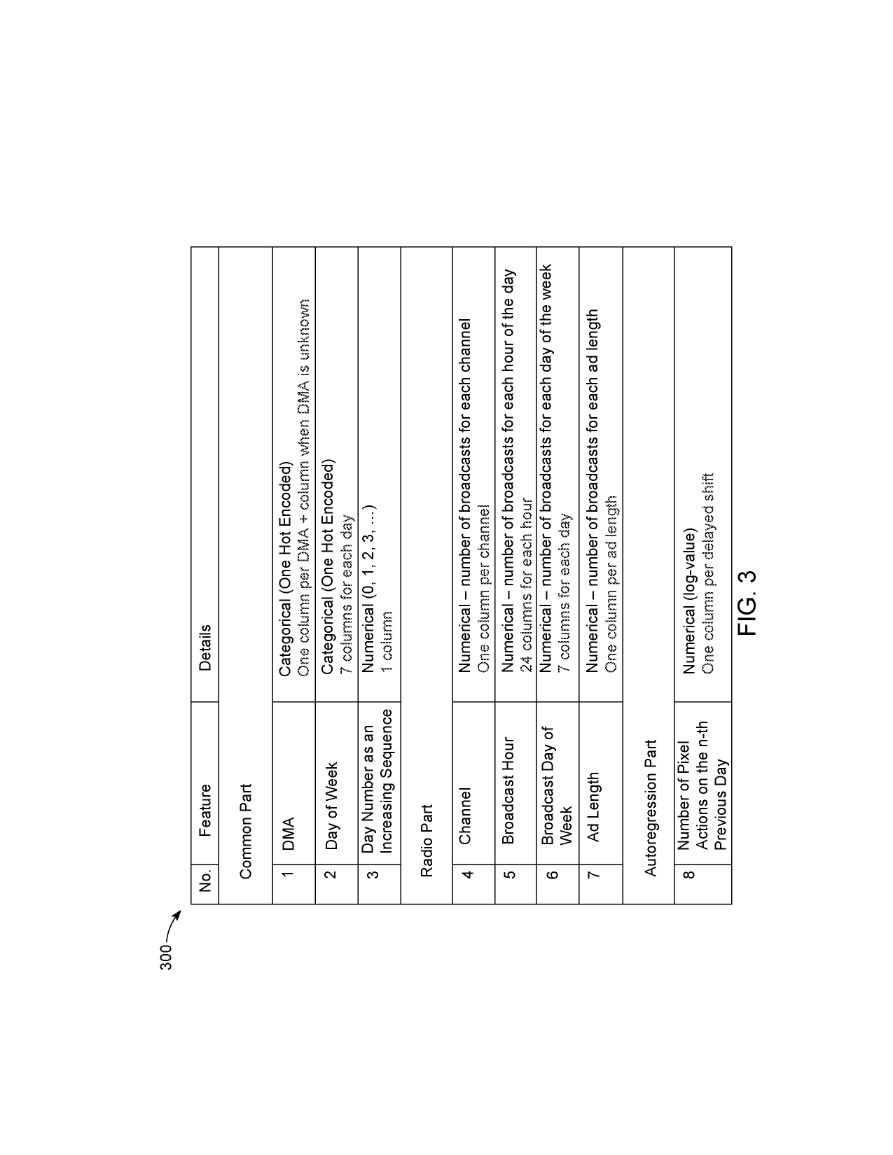

In some embodiments, the linear regression model can be trained on data provided for a specific campaign. The training process can include fitting the model to the input features (e.g., the common part, radio part, and autoregression part as illustrated in FIG. 3) and the target variable (e.g., the number of conversions or conversion rate). The linear regression model can be a basic fitting function that does not require deep learning techniques, while still providing accurate predictions of conversion events based on broadcast advertising exposure.

In some embodiments, the performance measurement component 116 can measure the return on advertising spend (ROAS), the return on investment (ROI), and/or performance parameters. In some embodiments, the performance measurement component 116 can measure the ROAS by identifying the conversions attributable to the promotional items in a broadcast media promotional cycle and determining the revenue generated from the identified conversions, as well as the cost associated with the promotional items in a broadcast media promotional cycle. The ROAS is the revenue divided by the cost. In some embodiments, the performance measurement component 116 can measure the ROI by determining the net profit generated from a broadcast media promotional cycle based on the conversions attributable to the promotional items in a broadcast media promotional cycle. The net profit can be the revenue from the conversions minus the total investment of the broadcast media promotional cycle. The ROI can be calculated by divided the net profit by the total investment. The ROI reflects the profitability after all costs are accounted for, while the ROAS focuses on revenue generated per dollar spent on the broadcast media promotional cycle, without considering other costs.

The performance parameters can include for example, the time of day that a message aired, the type of genre of the channel on which the message aired, the station on which the message aired, the format of the message, the template of the message, etc. The performance measurement component 116 can identify the performance parameters of the top performing promotional item(s). The top performing promotional item(s) can be those that have an incrementality and/or incremental contribution (e.g., lift) that exceed a threshold value. In some embodiments, the top performing promotional item(s) can the those that have an incrementality and/or incremental contribution in the top x% (e.g., top 10%) of promotional items in the broadcast media promotional cycle.

In some embodiments, the performance component 118 can provide the performance parameters (e.g., of all the promotional items in the broadcast media promotional cycle, or of the top performing promotional item(s) in the broadcast media promotional cycle), the predicted conversions (e.g., as measured by incrementality component 115), the incremental contribution (e.g., as measured by incremental component 115), the ROAS, the ROI, and/or other relevant information to a user device (e.g., client device 120A-Z) for presentation in a user interface (e.g., UI 124A-Z). In some embodiments, the performance component 118 can report the timeframe of the campaign (e.g., the broadcast media promotional cycle), the reach and frequency (e.g., as received from a broadcast media provider, and/or as measured by attribution component 114). In some embodiments, the AI model (e.g., of incrementality component 115) can calculate the reach and frequency based on the historical pattern of spots (e.g., advertisements) or impressions. In some embodiments, the performance component 118 can provide the performance parameters, the ROI, the ROAS, the attribution, the incrementality, the baseline attribution, other relevant data, and/or a combination of any of these data, to a large language model (LLM) for summarization, report generation, and/or interactive chat.

In some embodiments, the performance component 118 can provide the data to the LLM along with a prompt indicating a desired operation to be performed on the data. The prompt can include instructions specifying the type of output to be generated by the LLM based on the provided data. For example, the prompt can instruct the LLM to generate a summary of the broadcast media promotional cycle performance, including key metrics such as the total number of attributed conversions, the incrementality value, and the return on advertising spend. In some embodiments, the prompt can instruct the LLM to generate a report that includes one or more specified elements, such as a comparison of channel-specific conversion rates, an analysis of top-performing time slots or dayparts, an identification of underperforming promotional items, recommendations for optimizing future broadcast media promotional cycles, and/or a breakdown of performance by DMA.

In some embodiments, the performance component 118 can support an interactive chat mode for communicating with the LLM. In the interactive chat mode, the performance component 118 can submit the performance parameters, the ROI, the ROAS, the attribution, the incrementality, the baseline attribution, and/or other relevant data to the LLM, and a user can pose one or more questions regarding the data via a user interface (e.g., UI 124A-Z) of a client device (e.g., client device 120A-Z). The LLM can receive the user’s questions and generate responses based on the submitted data. For example, the user can ask questions such as “Which channels had the highest conversion rate?” or “How does the ROI of this campaign compare to the baseline attribution?” and the LLM can analyze the submitted data to provide responsive answers.

In some embodiments, when the LLM requires clarification or additional information to accurately respond to a user’s question, the LLM can generate one or more counter questions directed to the user. For example, if the user asks about the performance of a particular promotional item without specifying a time period, the LLM can generate a counter question requesting the user to specify the desired time period or lookback window. The user can provide the requested clarification, and the LLM can use the clarification along with the submitted data to generate a more accurate and relevant response. The interactive chat mode can enable users to explore the attribution and incrementality data in a conversational manner, facilitating deeper insights into the effectiveness of the broadcast media promotional cycle.

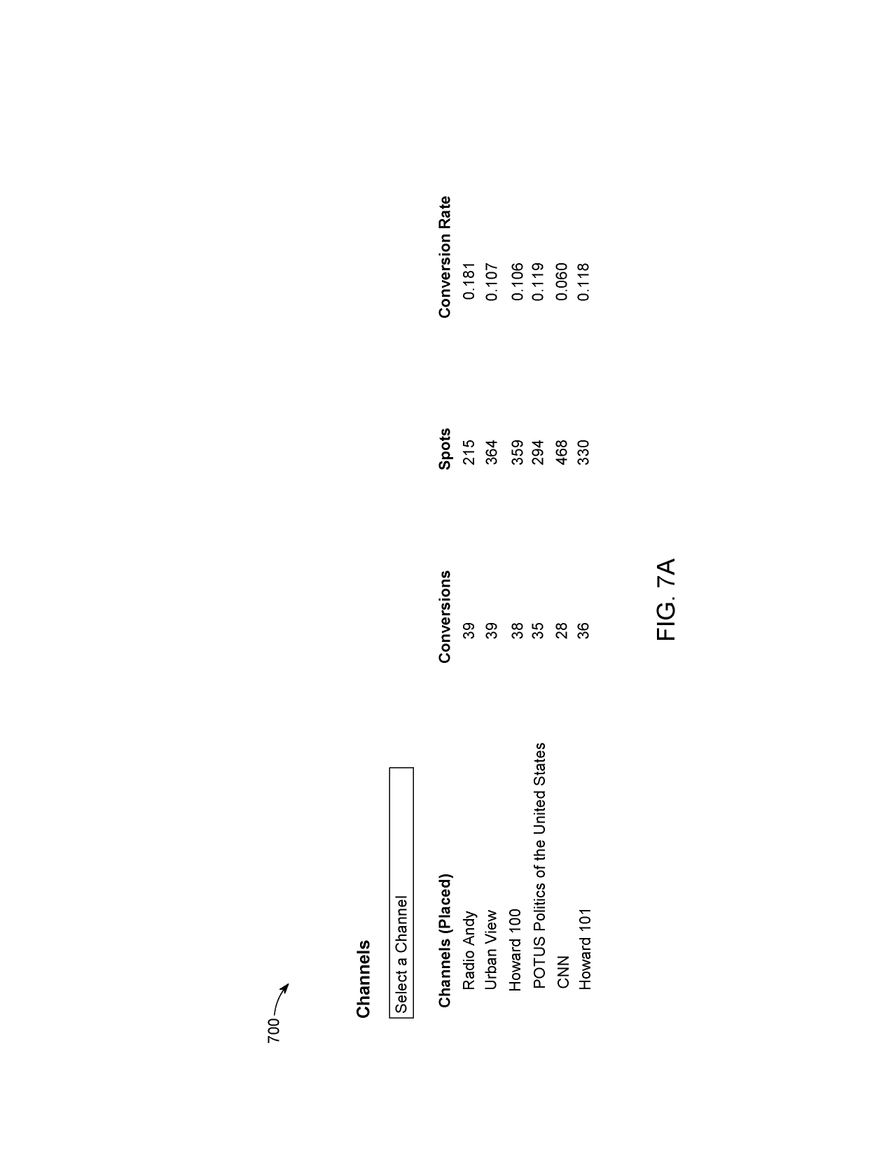

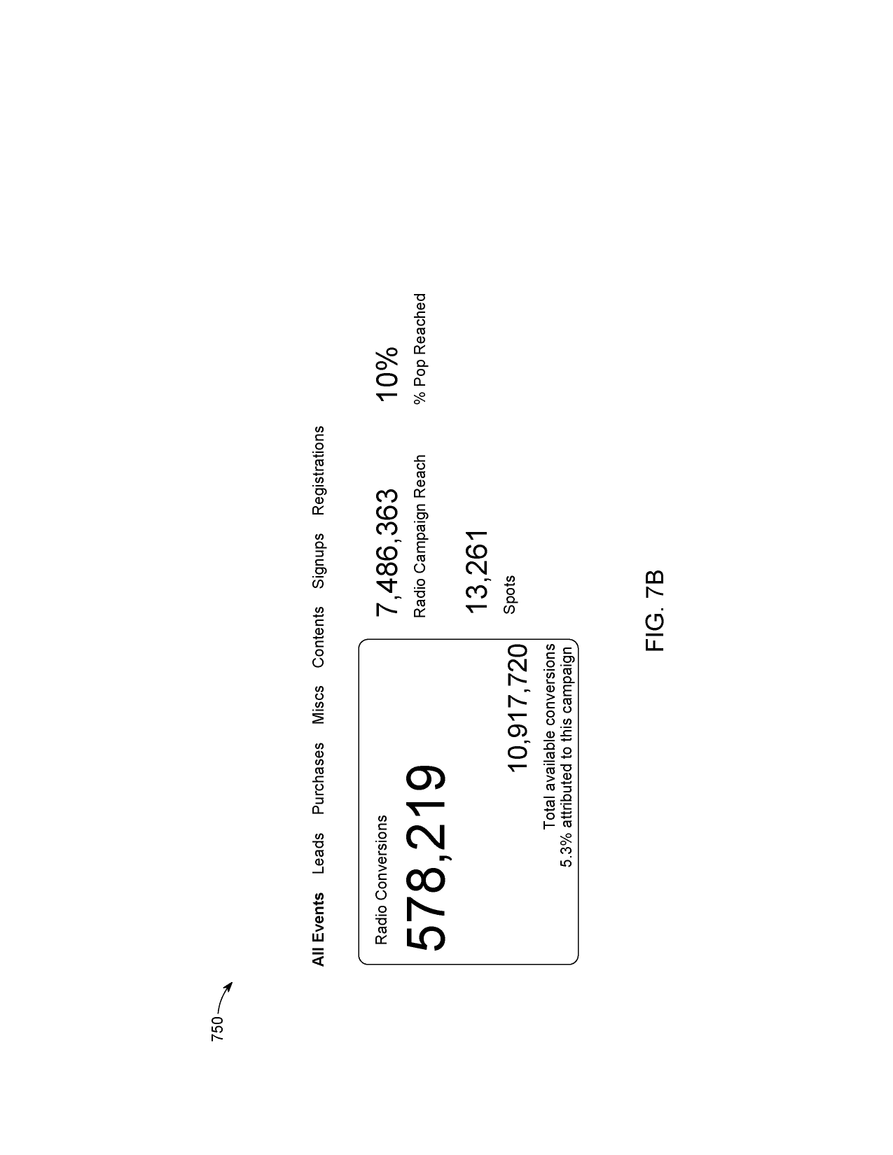

As an illustrative example, FIGS. 7A-B illustrate an example output of the performance component 118, as displayed by a UI 124A-Z of client device 120A-Z. For example, FIG. 7A illustrates an output 700 displaying the attribution conversions by channel or placement, as determined by the AI model of incrementality component 115, in accordance with one or more aspects of the present disclosure. As another example, FIG. 7B illustrates an output 750 displaying the broadcast attribution overview, showing the number of conversions attributed to broadcast (e.g., radio) advertisements, in accordance with one or more aspects of the present disclosure.

In some embodiments, the performance component 118 can determine a modified implementation schedule of a broadcast media promotional item of the broadcast media promotional cycle, e.g., based on the incremental contribution. For example, the performance component 118 can determine that the incremental contribution satisfies a threshold criterion. For example, the incremental contribution can fall below a threshold value, in which case the associated promotional item may be underperforming. The performance component 118 can modify the schedule to exclude the underperforming promotional item. In some embodiments, the performance component 118 can identify a broadcast media promotional item that is performing well (e.g., with an incremental contribution above a threshold value), and can replace the underperforming item with the item performing well in the schedule. The modified implementation can reflect the revised schedule. The performance component 118 can generate an instruction to implement the modified implementation, and can send the instruction to implement the modified implementation to a user device (e.g., client device 120A-Z). As an example, the instruction can cause the underperforming item to be removed from the schedule, replaced by the well-performing item.

In some embodiments, the server device 112 (e.g., broadcast attribution and incrementality module 111) can include a training set generator that can generate training data (e.g., a set of training inputs and target outputs) to train an AI model. The AI model may have already been trained, and further training may be performed to tailor the AI model to a particular advertisement campaign (e.g., a promotional cycle that includes broadcast media). In some embodiments, the training data set(s) can be stored in data store 140. In some embodiments, the training data sets can include a corpus of data, such as textual data, image data, and/or audio data. The training data sets can also include mapping data that maps the training inputs to target outputs. In some embodiments, the AI model can be a pre-trained foundational model, and a training engine can fine-tune the AI model on data pertaining to the promotional cycle, to generate more specific, or targeted, models. That is, the AI model can be campaign-specific. In some embodiments, the broadcast attribution and incrementality module 111 can gather data during a first time period of a planned promotional campaign (e.g., during the first x percent of the campaign), and can use the data to train or fine-tune the campaign-specific AI model. The broadcast attribution and incrementality module 111 can then run the campaign-specific AI model the rest of the duration of the campaign.

In some embodiments, a campaign-specific AI model can be trained or retrained using data from a particular advertising campaign. For campaigns that run for an extended duration (e.g., two months or more), the broadcast attribution and incrementality module 111 can train the model on data from a first portion of the campaign (e.g., the first four weeks). Once the model is trained on the initial data, the broadcast attribution and incrementality module 111 can run the trained model on new additional information from subsequent portions of the campaign without retraining the model. This approach can reduce computational resources required for model training while maintaining prediction accuracy throughout the campaign duration.

In some embodiments, the broadcast attribution and incrementality module 111 can determine whether sufficient data exists to generate a stable prediction for the incrementality calculation. For incrementality calculation, if there are few key performance indicator (KPI) events (e.g., less than 8,000 per week), then there may not be enough events per day per designated market area (DMA) for the AI model to develop a stable prediction. In some embodiments, when the number of KPI events for a particular KPI (such as purchases) is below a minimum threshold, the broadcast attribution and incrementality module 111 can first attempt to use overall events, which may be higher than any given individual KPI. The broadcast attribution and incrementality module 111 can use the overall distribution for each individual KPI if the individual KPI is not sufficient on its own to generate a reliable prediction. In some embodiments, if the total events are insufficient to meet the minimum threshold, the broadcast attribution and incrementality module 111 can prevent a model from being built, thereby avoiding unreliable predictions that could result from insufficient data. This minimum threshold can help ensure that the AI model has adequate data density across geographic regions and time periods to produce accurate and stable incrementality measurements.

In some embodiments, the fine-tuned training can be supervised, unsupervised, reinforced, or any other type of training. In some embodiments, the fine-tuning can include some elements of supervision, including learning techniques incorporating human and/or machine-generated feedback, undergoing training according to a set of guidelines, or training on a previously labeled set of data, etc. In some embodiments, the output of the AI model, during training, may be ranked by a user or automatically, according to a variety of factors (e.g., accuracy, acceptability, or any other metric useful in the fine-tuning portion of the training). The AI model can thus learn to favor these and any other factors relevant to users within an organization, or associated with a content item, when generating an output. In some embodiments, the AI model can include one or more pre-trained or fine-tuned models.

In some embodiments, the broadcast attribution and incrementality module 111 can validate the machine learning model output by comparing per capita conversions between markets with advertising and markets without advertising across different time periods. The validation can include comparing conversion rates before the campaign started, during the campaign, through any hiatus periods, through subsequent waves of advertising, and after the campaign ends. For example, markets that would later receive advertising may average a first percentage (e.g., 2.1%) more conversions per capita before the campaign, but during a first wave of the campaign, the difference may grow to a second percentage (e.g., 8.7%), showing a strong advertising effectiveness signal. During a hiatus period, the difference may drop to a third percentage (e.g., 0.6%). In a second wave of advertising, the difference may increase to a fourth percentage (e.g., 13.6%). After the campaign, a predictable advertising carryover effect can be observed. The machine learning model can produce an incrementality pattern that is in alignment with the raw data analyzed on a per capita conversion basis over time and among exposed and non-exposed markets.

FIG. 2 depicts a flow diagram of a method 200 for determining attribution and incrementality for broadcast media, in accordance with one or more aspects of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 may be performed by the broadcast attribution and incrementality module 111 of FIG. 1. In some embodiments, the method 200 may be executed by one or more processing devices of the server 112, to be presented to client devices 120A-120Z.

For simplicity of explanation, the method 200 of this disclosure is depicted and described as a series of acts. However, acts in accordance with this disclosure can occur in various orders and/or concurrently, and with other acts not presented and described herein. Furthermore, not all illustrated acts may be required to implement the method 200 in accordance with the disclosed subject matter. In addition, those skilled in the art will understand and appreciate that the method 200 could alternatively be represented as a series of interrelated states via a state diagram or events. Additionally, it should be appreciated that the method 200 disclosed in this specification are capable of being stored on an article of manufacture (e.g., a computer program accessible from any computer-readable device or storage media) to facilitate transporting and transferring such method to computing devices.

At operation 202, the processing logic receives an event log corresponding to a broadcast media promotional cycle. In some embodiments, the event log can be stored in data store 140 of FIG. 1. The event log can include multiple entries, and each entry can include at least region data (e.g., DMA, zip code, county, city, etc.), date data, and promotion placement data. In some embodiments, the date data can include the flight dates observed, e.g., the date data corresponding to the lookback window. In some embodiments, each entry can be identified by a DMA and date pair. For example, the promotion placement data can be grouped by date and region. In some embodiments, the promotion placement data can include event details (e.g., name of advertiser, the title of the advertisement or the name of the promotional campaign, the duration of the advertisement), air times (e.g., specific date and time the advertisement aired or is scheduled to air, the name of the program or show during which the advertisement ran or will run), channel on which the advertisement aired (or is scheduled to air), placement (e.g., positing within an advertisement break, priority level, or category), frequency (e.g., number of times the advertisement aired during a given time period), etc.

In some embodiments, the processing logic can identify time series data corresponding to the broadcast media promotional cycle. In some embodiments, the time series data can be stored in data store 140 of FIG. 1. The time series data can represent a time series curve, displaying conversion data points over a particular time period. The particular time period can be, or include, the lookback window corresponding to the broadcast media promotional cycle.

At operation 204, the processing logic processes the event log to determine a first conversion rate corresponding to the broadcast media promotional cycle. In some embodiments, processing logic provides, as a first input, the event log to an AI model trained to provide a conversion rate corresponding to the broadcast media promotional cycle. In some embodiments, the processing logic can provide, as additional first input, the time series data corresponding to the broadcast media promotional cycle. FIG. 3 depicts a table 300 illustrating an example of the input features for the AI model, in accordance with one or more aspects of the present disclosure. The input features can include, for example, the DMA, the day of the week, the day number as an increasing sequence, the channel, the broadcast hour, the broadcast day of the week, the promotion length, and/or the number of pixel actions on the n-th previous day. A pixel action can refer to a specific event or activity that is tracked by a tracking pixel (e.g., a small piece of code embedded on a website, app, or email) to measure user interactions and conversion. In some embodiments, the pixel actions represent the conversion of the time series data. In some embodiments, as first input to the AI model, the processing logic can provide all input features of FIG. 3.

In some embodiments, to account for population differences between DMAs, the processing logic can apply a scaling factor to the input features. The scaling factor can be the ratio of the average number of conversions within a DMA to the sum of the averages across all DMAs. For example, if a first DMA has an average of 100 conversions and the sum of averages across all DMAs is 1,000 conversions, the scaling factor for the first DMA would be 0.1 (100 divided by 1,000). The scaling factor can be applied to the broadcast-related input features (e.g., the radio part of the input features illustrated in FIG. 3) to normalize the data and account for the fact that larger DMAs may have more conversions simply due to their larger population, rather than due to the effectiveness of the broadcast advertising. In some embodiments, to prevent data leakage, the scaling factor can be calculated using data from days that are discarded due to autoregression. That is, the days used to calculate the scaling factor can be separate from the days used to train or run the AI model, ensuring that information from the training or inference period does not influence the scaling factor calculation.

In some embodiments, the event log provided as the first input to the AI model at operation 204 can include input features including, for example, a common part, a radio part (or broadcast part), and an autoregression part, as illustrated in FIG. 3. The common part can include a designated market area (DMA) feature comprising categorical data identifying a geographic region associated with each entry of the plurality of entries. The common part can include a day of week feature comprising categorical data identifying a day of the week associated with each entry of the plurality of entries. The common part can include a day number feature comprising numerical data representing a sequential day number within the broadcast media promotional cycle, such as 0, 1, 2, 3, and so on.

In some embodiments, the broadcast part (e.g., radio part, as illustrated in FIG. 3 ) of the input features can include a channel feature that includes numerical data representing a number of broadcasts for each channel on which broadcast media promotional items aired. The channel feature can include one column per channel. The radio part can include a broadcast hour feature including numerical data representing a number of broadcasts for each hour of a day during which broadcast media promotional items aired. The broadcast hour feature can include 24 columns for each hour of the day. The radio part can include a broadcast day of week feature including numerical data representing a number of broadcasts for each day of the week during which broadcast media promotional items aired. The broadcast day of week feature can include seven columns for each day. The radio part can include a promotion length feature including numerical data representing a number of broadcasts for each promotion length of the broadcast media promotional items. The promotion length feature can include one column per promotion length.

In some embodiments, the autoregression part of the input features can include a pixel action feature that includes numerical data representing a number of pixel actions on one or more previous days, as illustrated in FIG. 3. A pixel action can correspond to a conversion event tracked by a tracking pixel. A tracking pixel can be a small piece of code embedded on a website, application, or email to measure user interactions and conversions. In some embodiments, the pixel action feature uses log-transformed values and includes one column per delayed shift (e.g., one column for pixel actions on the first previous day, one column for pixel actions on the second previous day, and so on). The pixel actions can represent the conversions of the time series data. In some embodiments, each row of the input dataset provided to the AI model is identified by a DMA and date pair, corresponding to the region data and date data of the event log entries. The autoregression part can enable the AI model to incorporate historical conversion patterns when predicting future conversions, thereby improving the accuracy of the model's predictions by accounting for temporal dependencies in consumer behavior.

In some embodiments, the pixel action feature of the autoregression part can use log-transformed values to reduce skewness in the data distribution. The pixel action feature can include one column per delayed shift, where each column represents the number of pixel actions on a specific previous day. For example, a first column can represent the number of pixel actions on the first previous day (e.g., one day before the current date), a second column can represent the number of pixel actions on the second previous day (e.g., two days before the current date), and so on. The number of delayed shifts can be configured based on the lookback window or the duration of the broadcast media promotional cycle.

In some embodiments, the autoregression part can be used in conjunction with the common part and the radio part (or broadcast part) of the input features to provide a comprehensive set of inputs to the AI model. The autoregression part can capture the baseline level of conversion activity that would be expected based on historical patterns, while the radio part captures the impact of broadcast advertising. By including the autoregression part, the AI model can distinguish between conversions that are attributable to the broadcast media promotional cycle and conversions that would have occurred regardless of the advertising based on historical trends.

In some embodiments, certain days of data can be discarded due to autoregression requirements. For example, if the autoregression part requires pixel action data from the previous n days, then the first n days of the campaign period may not have sufficient historical data to populate the autoregression features. These discarded days can be used for other purposes, such as calculating scaling factors to account for population differences between designated market areas (DMAs), thereby preventing data leakage between the scaling factor calculation and the model training or inference periods.

In some embodiments, the processing logic can apply data preprocessing techniques to the input features before providing the input features to the AI model. The data preprocessing techniques can include z-normalization and/or log-transformation. Z-normalization (also referred to as standardization) can be applied to numerical features, wherein each feature value is adjusted by subtracting the mean of the feature values and dividing by the standard deviation of the feature values. Z-normalization can transform the numerical features to have a mean of zero and a standard deviation of one, which can improve the performance and convergence of the AI model by ensuring that features with different scales contribute equally to the model's predictions. In some embodiments, log-transformation can be applied to a target variable (e.g., the number of conversions or the conversion rate that the AI model is trained to predict). Log-transformation can reduce skewness in the data distribution and can help the AI model better capture relationships between the input features and the target variable, particularly when the target variable spans a wide range of values or exhibits exponential growth patterns. In some embodiments, the pixel action feature of the autoregression part of the input features (as illustrated in FIG. 3) can use log-transformed values, wherein the number of pixel actions on previous days is log-transformed before being provided to the AI model.

In some embodiments, the AI model is trained to provide a conversion rate corresponding to the broadcast media promotional cycle. In some embodiments, the conversion rate provided by the AI model can represent the number of conversions per capita for the particular region. In some embodiments, the AI model is trained to provide the number of conversions, and the processing logic determines the conversion rate using data (e.g., stored in data store 140) associated with the region data. In some embodiments, the AI model combines machine learning, shuffle sampling, and counterfactual analysis to evaluate differences in conversions in relationship to differences in advertising weight from multiple angles, as further described throughout.

The processing logic receives, as first output from the AI model, a first conversion rate corresponding to the broadcast media promotional cycle. The first conversion rate can represent the predicted conversion rate for a particular region (e.g., corresponding to the region data) having been provided the broadcast media promotional messages of the promotion placement data.

At operation 206, the processing logic processes a subset of the event log to determine a second conversion rate corresponding to the broadcast media cycle. The subset can include multiple entries identified at operation 202, without the promotion placement data. In some embodiments, the processing logic provides, as a second input, the subset of the event log to the AI model. The processing logic can provide, as additional second input, the time series data corresponding to the broadcast media promotion cycle. In some embodiments, as second input to the AI model, the processing logic can provide the DMA, the day of the week, the day number as an increasing sequence, and the number of pixel actions on the n-th previous day of FIG. 3. That is, in some embodiments, the second input to the AI model may not include the channel, broadcast hour, broadcast day of the week, or the promotion length (e.g., the promotion placement data).

In some embodiments, the subset of the event log provided as the second input to the AI model at operation 206 can include the designated market area feature, the day of week feature, the day number feature, and/or the pixel action feature comprising numerical data. In some embodiments, the subset of the event log provided as the second input to the AI model does not include the broadcast-specific features that indicate when, where, and how the broadcast media promotional items aired. By excluding these promotion placement features from the second input, the AI model can generate a second conversion rate representing the predicted conversions for the geographic region as if the broadcast media promotional messages had not been provided, enabling the processing logic to determine the incrementality value by comparing the first conversion rate (with promotion placement data) to the second conversion rate (without promotion placement data).

The processing logic receives, as a second output from the AI model, a second conversion rate corresponding to the broadcast media promotional cycle. The second output can represent the predicted conversion rate for a particular region (e.g., corresponding to the region data) having not been provided the broadcast media promotional messages of the promotion placement data.

At operation 208, the processing logic determines, based on the first conversion rate and the second conversion rate, an incrementality value corresponding to the broadcast media promotional cycle. In some embodiments, the processing logic can determine the difference between the first conversion rate and the second conversion rate to determine the incrementality value. The incrementality value can represent the incremental lift attributable to the broadcast media promotional messages of the promotion placement data.

In some embodiments, determining the incrementality value at operation 208 can include performing shuffle sampling to develop a reliable measure of the true impact of broadcast advertising. The processing logic can select, based on the region data of the plurality of entries, combinations of geographic regions (e.g., DMAs, zip codes, counties, or other regional distinctions). The geographic regions can include geographic regions that have varying degrees of exposure to the broadcast media promotional cycle. For example, some geographic regions may have received no broadcast media promotional items, some may have received a lighter volume of broadcast media promotional items, some may have received a moderate volume, and some may have received a heavier volume. By selecting different combinations of these geographic regions, the processing logic can analyze the relationship between advertising exposure levels and conversion rates across multiple regional groupings.

In some embodiments, the processing logic can generate, for each combination of geographic regions, a distribution of exposure versus non-exposure to the broadcast media promotional cycle. The distribution can represent the density of conversions observed in exposed markets compared to unexposed markets, or in markets with heavier exposure compared to markets with lighter exposure. The processing logic can use the distributions to separate a signal of broadcast advertising impact from noise. The noise can comprise at least one of seasonality effects (e.g., increased conversions during holiday shopping periods), other advertising mediums (e.g., digital advertising, direct mail, or other promotional channels running concurrently), and/or marketplace effects (e.g., competitor activity, economic conditions, or other external factors influencing consumer behavior). By analyzing the difference in density between exposed and unexposed market distributions, the processing logic can isolate the signal attributable to the broadcast media promotional cycle from the noise of confounding factors.

In some embodiments, the processing logic can adjust, using a machine learning model, the incrementality value until false positive signals are neutralized. A false positive signal can occur when the machine learning model attributes conversions to the broadcast media promotional cycle that were actually caused by seasonality, other advertising mediums, and/or marketplace effects. To neutralize false positive signals, the machine learning model can apply advertising weight from geographic regions that received the broadcast media promotional cycle to geographic regions that did not receive the broadcast media promotional cycle (a counterfactual approach). To the extent the machine learning model produces a false positive signal in the counterfactual scenario (e.g., predicting incremental conversions in regions that did not actually receive advertising), the machine learning model can adjust the incrementality value downward until the false positive signal is neutralized. This adjustment helps ensure that the broadcast attribution is accurate and is not over-attributing conversions due to seasonality or multicollinearity effects. Based on the adjusted incrementality value, the processing logic can determine a measure of incremental contribution caused by the broadcast media promotional cycle, representing the conversions that would not have occurred without the broadcast advertising.

In some embodiments, determining the incrementality value at operation 208 can include performing counterfactual analysis to isolate the impact of the broadcast media promotional cycle. The processing logic can identify, from the plurality of entries, a first set of geographic regions that received the broadcast media promotional cycle and a second set of geographic regions that did not receive the broadcast media promotional cycle. For example, in a local broadcast campaign, some DMAs may have received broadcast media promotional items while other DMAs did not receive any broadcast advertising. The processing logic can use the second set of geographic regions that did not receive advertising as a control group for comparison against the first set of geographic regions that received advertising.

In some embodiments, the processing logic can determine, using the AI model, a first predicted conversion rate for the first set of geographic regions based on the promotion placement data. The first predicted conversion rate can represent the expected conversions in regions where the broadcast media promotional items actually aired. The processing logic can then generate a counterfactual scenario by applying advertising weight from the first set of geographic regions to the second set of geographic regions that did not receive the broadcast media promotional cycle. That is, the processing logic can take the advertising weight (e.g., the number of spots, impressions, or reach) from a DMA that received advertising and apply that weight to a DMA where the advertising did not actually run, simulating what would have happened if that region had received the same level of advertising exposure.

In some embodiments, the processing logic can determine, using the AI model, a second predicted conversion rate for the counterfactual scenario. The second predicted conversion rate can represent the conversions the AI model would predict for the second set of geographic regions if those regions had received the advertising weight from the first set of geographic regions. The processing logic can detect, based on a comparison of the first predicted conversion rate and the second predicted conversion rate, whether a false positive signal exists. A false positive signal can occur when the AI model predicts incremental conversions in the counterfactual scenario for regions that did not actually receive advertising, indicating that the model may be attributing conversions to factors other than the broadcast advertising, such as seasonality or other marketplace effects.

In some embodiments, the processing logic can adjust, in response to detecting the false positive signal, the incrementality value until the false positive signal is neutralized. For example, if the AI model produces a false positive signal by predicting incremental conversions in the counterfactual scenario, the processing logic can adjust the incrementality value downward to account for the portion of conversions that are attributable to factors other than the broadcast media promotional cycle. This adjustment helps ensure that the broadcast attribution is accurate and is not over-attributing conversions due to seasonality or multicollinearity effects. Based on the adjusted incrementality value, the processing logic can identify an impact of the broadcast media promotional cycle attributable to the broadcast media promotional items, representing the true incremental contribution of the broadcast advertising to the conversion events.

In some embodiments, determining the incrementality value at operation 208 can include cross-sectional regional analysis. Processing logic can identify, from the region data of the plurality of entries, geographic regions that have varying volumes of advertising delivery. The varying volumes can include at least a first volume level, a second volume level, and a third volume level. For example, the first volume level can correspond to geographic regions (e.g., DMAs, zip codes, counties, or other regional distinctions) that received a lighter volume of broadcast media promotional items, the second volume level can correspond to geographic regions that received a moderate volume of broadcast media promotional items, and the third volume level can correspond to geographic regions that received a heavier volume of broadcast media promotional items. In some embodiments, the volume levels can be determined based on spot count (e.g., the number of advertisements that aired in a particular time period), total impressions, and/or reach and frequency data for each geographic region.

In some embodiments, the processing logic can perform a cross-sectional regional analysis by comparing conversion rates across the plurality of geographic regions based on the varying volumes of advertising delivery. The cross-sectional regional analysis can observe the relationship between advertising exposure levels and conversion events within a time interval. For example, the processing logic can compare the conversion rates of geographic regions with heavier advertising exposure to the conversion rates of geographic regions with lighter advertising exposure to identify a causal relationship between broadcast advertising and conversions. The cross-sectional regional analysis can provide insights into how different levels of advertising delivery correlate with different levels of consumer response across the plurality of geographic regions.

In some embodiments, the processing logic can generate a time series model representing trends in conversions over a time period corresponding to the broadcast media promotional cycle. The time series model can observe the statistical relationship between the delivery of broadcast promotional messages and conversion events over time. The time series model can show how advertising influences consumer behavior by tracking conversion patterns before, during, and after the broadcast media promotional cycle. In some embodiments, the time series model can include a pre-period before advertising started and a post-period to observe carry-over effects of advertising within a lookback window.

In some embodiments, the processing logic can supplement the time series model with the cross-sectional regional analysis to address multicollinearity. Multicollinearity can include multiple factors simultaneously influencing conversion events. For example, an online store may promote gifts for a holiday season, and broadcast advertising may begin at the same time that consumers begin to shop for holiday gifts. In this scenario, the time series corresponding to the conversions may not accurately identify how much of the website visits and sales are due to the broadcast advertising versus the seasonal shopping behavior. Another example of multicollinearity is when a broadcast advertising campaign coincides with the launch of a new product or with other advertising media starting around the same time. Multicollinearity can lead to one media getting credit for another media's contribution. By complementing the time series model with the cross-sectional regional analysis, the processing logic can control for multicollinearity and achieve a more accurate measure of the true incremental contribution of the broadcast media promotional cycle to the conversion events.

In some embodiments, the processing logic can determine, based on the complemented time series model and the cross-sectional regional analysis, the incrementality value representing an incremental contribution of the broadcast media promotional cycle to the conversion events. The combination of the time series model and the cross-sectional regional analysis can provide multiple angles for evaluating differences in conversions in relationship to differences in advertising weight. The incrementality value determined using this complemented approach can represent a more reliable and accurate measure of the true impact of broadcast advertising by accounting for confounding factors such as seasonality, other advertising mediums, and marketplace effects that may otherwise distort the attribution measurement.

At operation 210, the processing logic determines a baseline attribution of the broadcast media promotional cycle corresponding to at least one promotional message of the broadcast media promotional cycle. The baseline attribution can include reach and/or frequency data. The at least one promotional message can correspond to a conversion event of a consumer (e.g., performed on a client device 120A-Z).

In some embodiments, the baseline attribution corresponds to a random duplication determined by deriving a rolling reach curve across a time period (e.g., a lookback window) and multiplying by the total conversions in that same time period. The rolling reach curve can correspond to the reach and frequency over the lookback window.

In some embodiments, determining the baseline attribution at operation 210 can include applying a decay curve to weight the impact of broadcast advertising impressions within the lookback window. The decay curve can represent the decreasing probability that a broadcast advertisement will influence a conversion event as time passes from the initial exposure. For example, an impression that occurred one day before a conversion event can receive a higher weight than an impression that occurred six days before the conversion event. The weighted impressions can be used to calculate a more accurate baseline attribution that accounts for the diminishing influence of advertising exposure over time. In some embodiments, the decay curve applied to broadcast advertising can be similar to the decay curve observed for digital advertising, providing a consistent methodology for calculating attribution across both broadcast and digital promotional cycles.

In some embodiments, the baseline attribution is determined by multiplying a rolling reach of the broadcast media promotional cycle by a total number of conversion events in a geographical region during the particular lookback window. The rolling reach of the broadcast media promotional cycle can represent an accumulation of incremental reach within a population. That is, for each subsequent airing of a promotional message, there is a certain number of people who were already reached by a previous airing, which increases the frequency, and there is a certain number of people that are incremental, that were not reached by a previous airing of the promotional message. The rolling reach can be derived by analyzing the average listening or viewing patterns of different people over time to create a cumulative reach curve. The processing logic can multiply the rolling reach by the total number of conversion events in the geographical region during the lookback window to determine the baseline attribution. In some embodiments, this baseline attribution corresponds to a random duplication measurement, which represents the statistical overlap between the population reached by the broadcast media promotional cycle and the population that converted during the lookback window.

At operation 212, the processing logic determines an incremental contribution corresponding to the broadcast media promotional cycle by applying the incrementality value to the baseline attribution of the broadcast media promotional cycle (e.g., the random duplication determined by deriving a rolling reach curve across the lookback window and multiplying by the total conversions in that same time period, as described with respect to operation 210). Applying the incrementality value to the baseline attribution can include adding the incrementality to the baseline attribution, which produces the attributable conversions. The incremental contribution can represent the attribution for the broadcast media promotional cycle. In some embodiments, the baseline attribution, the incrementality value, and/or the incremental contribution can correspond to particular lookback window of a duration of the broadcast media promotional cycle.

In some embodiments, the incremental contribution determined at operation 212 provides a broadcast attribution measurement that is comparable to a digital attribution measurement for a corresponding digital promotional cycle. The comparability can be achieved by combining the baseline attribution derived from random duplication of the rolling reach with the incrementality value to produce an attribution count on par with digital path-to-purchase attribution counting. That is, digital attribution methodologies count impressions that occurred on a consumer's path to purchase during a campaign plus a lookback window, attributing conversions to recent exposure to digital advertising. By deriving the baseline attribution from the rolling reach (which represents the cumulative number of unique individuals exposed to the broadcast promotional message over the lookback window) and adding the incrementality value (which represents the incremental conversions caused by the broadcast advertising), the processing logic produces a broadcast attribution count that is consistent with how digital impressions are attributed and counted. This consistency enables advertisers to accurately and meaningfully compare the effectiveness of broadcast media promotional cycles with digital promotional cycles on a level playing field, rather than comparing disparate measurement methodologies that would yield incomparable results.

At operation 214, the processing logic determines, based on the incremental contribution, one or more performance measurements corresponding to the broadcast media promotional cycle. The performance measurements can include, for example, a return on investment and/or a return on advertisement spend for the broadcast media promotional cycle. In some embodiments, the performance measurements can include the time of day that the message(s) air, the type of genre of the channel on which the message(s) air, the station on which the message(s) air, the format of the message(s), the template of the message(s) for the top performing promotional media items of the broadcast media promotional cycle.

In some embodiments, determining the one or more performance measurements at operation 214 can include identifying, from the promotion placement data of the plurality of entries, channels on which broadcast media promotional items of the broadcast media promotional cycle aired. The channels can include, for example, radio stations, television channels, satellite radio channels, or other broadcast media outlets. The processing logic can parse the promotion placement data to identify each unique channel on which one or more broadcast media promotional items aired during the broadcast media promotional cycle.

In some embodiments, the processing logic can determine, for each channel, a channel-specific conversion rate based on the incremental contribution. The channel-specific conversion rate can represent the ratio of conversions attributed to broadcast media promotional items aired on the channel to the total number of broadcast media promotional items (e.g., spots) aired on the channel. The processing logic can also determine, for each channel, a channel-specific attribution count representing a number of conversions attributed to broadcast media promotional items aired on the channel. The channel-specific attribution count can represent the portion of the incremental contribution that is attributable to the broadcast media promotional items that aired on the particular channel.

In some embodiments, the processing logic can rank the channels based on the channel-specific conversion rate and/or the channel-specific attribution count. For example, the processing logic can rank the channels from highest to lowest based on the channel-specific conversion rate to identify which channels are most effective at driving conversions per spot aired. Alternatively or additionally, the processing logic can rank the channels based on the channel-specific attribution count to identify which channels are responsible for the greatest number of attributed conversions. The ranking can enable advertisers to identify top-performing channels and underperforming channels within the broadcast media promotional cycle.

In some embodiments, the processing logic can provide, to the user device, a channel performance report comprising the channel-specific conversion rate and/or the channel-specific attribution count for each channel of the plurality of channels. The channel performance report can be displayed in a user interface of the user device, such as a dashboard or table format. For example, as illustrated in FIG. 7A, the channel performance report can display a list of channels along with corresponding conversions, spots, and conversion rates for each channel, enabling users to compare the effectiveness of different channels within the broadcast media promotional cycle.

In some embodiments, the processing logic can identify, from the promotion placement data, one or more placements corresponding to shows or programs during which the broadcast media promotional items aired. The placements can include, for example, specific radio programs, television shows, podcast episodes, or other programming content during which the broadcast media promotional items were aired. The processing logic can parse the promotion placement data to identify each unique placement associated with the broadcast media promotional items.

In some embodiments, the processing logic can determine, for each placement, a placement-specific conversion rate based on the incremental contribution. The placement-specific conversion rate can represent the ratio of conversions attributed to broadcast media promotional items aired during the placement to the total number of broadcast media promotional items aired during the placement. The processing logic can also determine, for each placement, a placement-specific attribution count representing a number of conversions attributed to broadcast media promotional items aired during the placement. The placement-specific attribution count can represent the portion of the incremental contribution that is attributable to the broadcast media promotional items that aired during the particular show or program.

In some embodiments, the processing logic can provide, to the user device, a placement performance report comprising the placement-specific conversion rate and/or the placement-specific attribution count for each placement of the plurality of placements. The placement performance report can enable advertisers to evaluate the effectiveness of broadcast media promotional items at the show or program level, identifying which specific programming content is most effective at driving conversions. This granular level of attribution can enable advertisers to optimize their broadcast media promotional cycles by allocating resources to placements that demonstrate higher conversion rates or attribution counts.

At operation 216, the processing logic provides, to a user device, at least one of the incremental contribution or the one or more performance measurements corresponding to the broadcast media promotional cycle, e.g., for presentation in a user interface.

In some embodiments, the incremental contribution determined at operation 212 provides a broadcast attribution measurement that is proportionate to a digital attribution measurement for a corresponding digital promotional cycle. The broadcast attribution measurement can be accurately and meaningfully compared to the digital attribution measurement because both measurements are derived using consistent attribution counting methodologies. That is, the combination of the baseline attribution (derived from random duplication of the rolling reach) and the incrementality value produces an attribution count that is on par with digital path-to-purchase attribution counting. This proportionality enables advertisers to evaluate the relative effectiveness of broadcast and digital promotional cycles on a level playing field.

In some embodiments, the processing logic can compare the broadcast attribution measurement to the digital attribution measurement for the corresponding digital promotional cycle. The corresponding digital promotional cycle can be a digital promotional cycle that has a similar marketing objective as the broadcast media promotional cycle, such as promoting the same product, service, and/or brand. Based on the comparison, the processing logic can determine an adjusted implementation of at least one of the broadcast media promotional cycle or the corresponding digital promotional cycle. The adjusted implementation can reduce computing resources used to implement the at least one of the broadcast media promotional cycle or the corresponding digital promotional cycle by modifying a schedule to remove one or more underperforming promotional items. For example, if the comparison indicates that the broadcast attribution measurement for a particular broadcast media promotional item is greater than the digital attribution measurement for a corresponding digital promotional item, the processing logic can determine that the digital promotional item is underperforming relative to the broadcast media promotional item. The adjusted implementation can include removing the underperforming digital promotional item from the schedule, thereby reducing the computing resources (e.g., processing resources, bandwidth, storage, and so on) that would otherwise be used to implement the underperforming digital promotional item.

In some embodiments, the processing logic can generate an instruction to implement the adjusted implementation and provide the instruction to the user device. The instruction can cause the user device to modify the schedule for airing the broadcast media promotional cycle and/or the corresponding digital promotional cycle according to the adjusted implementation. For example, the instruction can cause the user device to remove one or more underperforming promotional items from the schedule, replace underperforming items with better-performing items, or reallocate resources from underperforming promotional cycles to better-performing promotional cycles. By comparing like measurements (broadcast attribution and digital attribution) and adjusting the implementation accordingly, aspects of the present disclosure can reduce the consumption of computing resources not only in the determination and analysis of the attribution, but also in the implementation of the promotional cycles themselves.

In some embodiments, the processing logic can determine, based on the incremental contribution, a modified implementation of a second broadcast media promotional item of the broadcast media promotional cycle. The processing logic can generate, based on the modified implementation, an instruction to implement the modified implementation. The processing logic can provide, to the user device, the instruction to implement the modified implementation. For example, the modified implementation can include a change in a time of day, a genre, a station, a format, and/or a version of the second broadcast media promotional item corresponding to an improved performance (e.g., the highest conversion rate or highest number of conversions for the second broadcast media promotional item). The instruction can instruct the user device to modify a schedule for airing the broadcast media promotional item to include the time of day, the genre, the station, the format, and/or the version of the modified implementation. That is, the instruction can be an instruction to modify a schedule to air the second broadcast media promotional item at the time of day indicated in the modified implementation.

FIG. 3 depicts an example of the input features table 300 that illustrates the various input features used by the AI model for broadcast attribution and incrementality calculation, in accordance with one or more aspects of the present disclosure. The input features table 300 is organized into three main sections: a Common Part, a Radio Part (or Broadcast Part), and an Autoregression Part.

In some embodiments, the Common Part can include features that are common to both the first input (with promotion placement data) and the second input (without promotion placement data) provided to the AI model. The Common Part can include a designated market area (DMA) feature, which is categorical data that is one-hot encoded with one column per DMA plus a column for when the DMA is unknown. The Common Part can include a day of week feature, which is categorical data that is one-hot encoded with seven columns corresponding to each day of the week. The Common Part can include a day number feature, which is numerical data representing a sequential day number within the broadcast media promotional cycle (e.g., 0, 1, 2, 3, and so on) using one column.

In some embodiments, the Radio Part (or Broadcast Part) can include features specific to the broadcast media promotional items. The Radio Part can include a channel feature, which is numerical data representing the number of broadcasts for each channel on which broadcast media promotional items aired, with one column per channel. The Radio Part can include a broadcast hour feature, which is numerical data representing the number of broadcasts for each hour of the day during which broadcast media promotional items aired, with 24 columns corresponding to each hour. The Radio Part can include a broadcast day of week feature, which is numerical data representing the number of broadcasts for each day of the week during which broadcast media promotional items aired, with seven columns corresponding to each day. The Radio Part can include a promotion length feature (or ad length feature), which is numerical data representing the number of broadcasts for each promotion length of the broadcast media promotional items, with one column per promotion length.

In some embodiments, the Autoregression Part can include features that capture historical conversion patterns. The Autoregression Part can include a pixel action feature, which is numerical data representing the number of pixel actions on one or more previous days. A pixel action corresponds to a conversion event tracked by a tracking pixel embedded on a website, application, or email. The pixel action feature can use log-transformed values to reduce skewness in the data distribution and includes one column per delayed shift (e.g., one column for pixel actions on the first previous day, one column for pixel actions on the second previous day, and so on), in embodiments. The Autoregression Part can enable the AI model to incorporate historical conversion patterns when predicting future conversions, thereby improving the accuracy of the model's predictions by accounting for temporal dependencies in consumer behavior.

In some embodiments, each row of the input dataset provided to the AI model is identified by a DMA and date pair, corresponding to the region data and date data of the event log entries. In some embodiments, when the AI model receives the first input (the full event log), all features from the Common Part, Radio Part, and Autoregression Part are included. When the AI model receives the second input (the subset of the event log without promotion placement data), only the features from the Common Part and Autoregression Part are included, excluding the Radio Part features, in embodiments. The difference between the AI model’s outputs for these two inputs represents the incrementality value attributable to the broadcast media promotional cycle.

FIG. 4A depicts an impressions versus conversions graph 400 illustrating the relationship between promotion impressions and conversions across multiple designated market areas (DMAs), in accordance with one or more aspects of the present disclosure. The impressions versus conversions graph 400 displays a scatter plot with impressions on the horizontal axis and conversions on the vertical axis. Both axes use a logarithmic scale to accommodate the wide range of values across different market sizes, with impressions ranging from approximately 100,000 to 100,000,000 and conversions ranging from approximately 0 to 5,000.

In some embodiments, each data point on the impressions versus conversions graph 400 represents a different DMA, with labels identifying specific markets. Larger metropolitan areas such as Los Angeles, Dallas-Fort Worth, Houston, and San Francisco-Oakland appear in the upper right portion of the graph, indicating higher impression volumes and higher conversion counts. Smaller markets such as San Angelo, Amarillo, and Odessa-Midland appear in the lower left portion of the graph, indicating lower impression volumes and lower conversion counts.

In some embodiments, the impressions versus conversions graph 400 includes a trend line representing the mathematical relationship between impressions and conversions. For example, the trend line can follow a power function with the equation 0.0349x^0.704, indicating that conversions increase as impressions increase, but at a diminishing rate. The R-squared value of 0.907 can indicate a strong positive correlation between impressions and conversions across the various DMAs, demonstrating that approximately 90.7 percent of the variation in conversions can be explained by the variation in impressions.

In some embodiments, the impressions versus conversions graph 400 can provide visual evidence supporting the cross-sectional regional analysis used by the incrementality component 115. By observing the relationship between advertising exposure (impressions) and consumer behavior (conversions) across multiple geographic regions with varying levels of advertising delivery, the broadcast attribution and incrementality module 111 can identify a causal relationship between broadcast advertising and conversions. The strong correlation shown in the impressions versus conversions graph 400 indicates that regions with higher advertising exposure generally exhibit higher conversion rates, supporting the attribution of conversions to the broadcast media promotional cycle.

FIG. 4B depicts an ad spots versus conversions graph 420 illustrating the relationship between advertising exposure levels and the share of conversions across designated market areas (DMAs), in accordance with one or more aspects of the present disclosure. As illustrated in FIG. 4B, the graph 420 includes a horizontal axis labeled “Ad Spots” ranging from approximately 1,000 to 10,000 and a vertical axis labeled “Share of Conversions” ranging from 0.00% to approximately 80.00%.

In some embodiments, the graph 420 displays a curve that demonstrates the relationship between the number of advertisement spots aired in a region and the corresponding share of conversions attributable to that region. The curve begins at approximately 0% share of conversions at 1,000 ad spots and rises steeply through the initial exposure range. As the number of ad spots increases, the curve continues to rise but at a progressively decreasing rate, demonstrating diminishing returns on advertising investment.

In some embodiments, the graph 420 divides the exposure range into three categories: light exposure, moderate exposure, and heavy exposure. The light exposure category corresponds to regions with fewer ad spots (approximately 1,000 to 3,000), where the curve rises steeply, indicating that initial advertising investments yield significant increases in conversion share. The moderate exposure category corresponds to regions with a medium number of ad spots (approximately 3,000 to 6,000), where the curve continues to rise but at a decreasing rate. The heavy exposure category corresponds to regions with a higher number of ad spots (approximately 6,000 to 10,000), where the curve begins to plateau, indicating that additional advertising investments yield progressively smaller increases in conversion share.

In some embodiments, the graph 420 can provide visual evidence of the diminishing returns phenomenon in broadcast advertising. This information can be used by the incrementality component 115 to understand how advertising effectiveness varies across regions with different exposure levels and to inform recommendations for optimizing advertising spend across geographic regions.

FIG. 4C depicts an ad exposure chart 440 illustrating the distribution of advertising exposure across multiple designated market areas (DMAs), in accordance with one or more aspects of the present disclosure. As illustrated in FIG. 4C, the chart 440 displays a horizontal bar visualization with vertical lines of varying heights arranged from left to right, where each vertical line represents a different DMA.

In some embodiments, the DMAs in the chart 440 are sorted by their level of advertising exposure, with DMAs receiving lighter exposure positioned on the left side of the chart and DMAs receiving heavier exposure positioned on the right side of the chart. The height of each vertical line corresponds to the relative level of advertising delivery in that DMA, with taller lines indicating higher advertising exposure and shorter lines indicating lower advertising exposure.

In some embodiments, the chart 440 is divided into three labeled regions corresponding to the exposure categories used in the cross-sectional regional analysis. The left portion of the chart is labeled “lighter exposure,” indicating DMAs with below-average advertising delivery. The middle portion of the chart is labeled “moderate exposure,” indicating DMAs with average advertising delivery. The right portion of the chart is labeled “heavier exposure,” indicating DMAs with above-average advertising delivery.

In some embodiments, the chart 440 can provide a visual representation of the variation in advertising delivery across geographic regions, which is a key input to the cross-sectional regional analysis performed by the incrementality component 115. By comparing conversion rates across DMAs with varying levels of advertising exposure, the broadcast attribution and incrementality module 111 can isolate the impact of broadcast advertising from other factors that may influence conversions, such as seasonality, other advertising mediums, and marketplace effects.

FIG. 4D depicts a KPI impact graph 460 illustrating the relationship between broadcast advertising exposure and key performance indicator (KPI) impact, in accordance with one or more aspects of the present disclosure. As illustrated in FIG. 4D, the KPI impact graph 460 displays a curved line showing how KPI impact changes as the spot count (the number of advertisement spots aired) increases.

The horizontal axis of the KPI impact graph 460 represents the spot count, ranging from approximately 20,000 to 100,000 spots. The vertical axis represents a score metric corresponding to the KPI impact, ranging from approximately 17.5 to 32.5. The curved line demonstrates how incremental advertising exposure produces varying levels of impact on consumer behavior.

The KPI impact graph 460 can illustrate the phenomenon of diminishing returns in broadcast advertising. In the lower left portion of the graph, labeled “lighter exposure,” the curve rises steeply, indicating that initial advertising spots generate greater impact per spot. In the middle section of the graph, labeled “moderate exposure,” the curve continues to rise but at a decreasing rate, indicating that additional advertising spots generate progressively smaller incremental impact. In the upper right portion of the graph, labeled “heavier exposure,” the curve begins to plateau, indicating that the audience is approaching saturation and additional advertising spots generate minimal incremental impact.

In some embodiments, the KPI impact graph 460 can provide visual evidence supporting the incrementality calculation performed by the incrementality component 115. By understanding how advertising impact varies with exposure level, the broadcast attribution and incrementality module 111 can more accurately attribute conversions to the broadcast media promotional cycle and identify optimal advertising investment levels for different geographic regions.

FIG. 5A depicts a time series prediction graph 500 illustrating the relationship between predicted conversions and actual conversion data over time, in accordance with one or more aspects of the present disclosure. As illustrated in FIG. 5A, the time series prediction graph 500 displays three lines plotted against a time axis spanning from November 2022 through late December 2022.

The vertical axis of the time series prediction graph 500 represents the number of conversions, ranging from 0 to approximately 50,000. The horizontal axis represents dates within the broadcast media promotional cycle. The time series prediction graph 500 includes three distinct lines identified in a legend as “target,” “pred” (predicted), and “base.”

In some embodiments, the “target” line can represent the actual observed conversions during the broadcast media promotional cycle. In some embodiments, the “pred” line can represent the AI model’s prediction of expected conversions based on the full set of input features, e.g., including the promotion placement data from the Radio Part. In some embodiments, the “base” line represents the AI model’s prediction of expected conversions based on the input features without the promotion placement data, representing the baseline level of conversions that would be expected without the broadcast advertising.

In some embodiments, the difference between the “pred” line and the “base” line can represent the incremental impact of the broadcast advertising on conversions. The time series prediction graph 500 can demonstrate how the AI model separates the base level impact from the impact of broadcast advertising to determine the incrementality value, in embodiments.

In some embodiments, the time series prediction graph 500 can display performance metrics including an R² value of 0.94 and a lift value of 8.38. The R² value indicates that the AI model explains approximately 94 percent of the variation in conversions, demonstrating a high level of model accuracy. The lift value of 8.38 indicates that the broadcast advertising generated an 8.38 percent increase in conversions above the baseline level.

In some embodiments, the three lines in the time series prediction graph 500 follow similar patterns with notable fluctuations, showing periodic dips and peaks throughout the time period that likely correspond to weekly patterns in consumer behavior. The graph demonstrates a general upward trend toward the end of December, which may correspond to increased consumer activity during the holiday shopping season, for example.

FIG. 5B depicts a signal and noise learning graph 550 that illustrates the separation of signal from noise in the machine learning analysis for broadcast attribution, in accordance with one or more aspects of the present disclosure. As illustrated in FIG. 5B, the signal and noise learning graph 550 displays density distributions on the vertical axis (ranging from 0.0 to approximately 0.7) and a horizontal axis representing a metric scale (ranging from approximately -5 to 20).

In some embodiments, the signal and noise learning graph 550 can present three overlapping distribution curves identified in a legend as “Lift Estimation,” “Exposed Shuffling,” and “Unexposed Shuffling.” The “Exposed Shuffling” distribution can represent the density of conversions observed in geographic regions that received the broadcast media promotional cycle or received heavier exposure. This distribution appears as a tall, narrow peak on the horizontal axis. The “Unexposed Shuffling” distribution can represent the density of conversions observed in geographic regions that did not receive the broadcast media promotional cycle or received lighter exposure. This distribution appears as a broader, lower curve compared to the exposed distribution.

In some embodiments, the difference in position and shape between the exposed and unexposed distributions demonstrates the degree to which the machine learning algorithm is separating the signal of broadcast advertising impact from the noise of confounding factors. The noise can include seasonality effects (e.g., increased conversions during holiday shopping periods), other advertising mediums (e.g., digital advertising running concurrently), and marketplace effects (e.g., competitor activity or economic conditions).

In some embodiments, the “Lift Estimation” line in the signal and noise learning graph 550 can represent the observed lift over baseline, indicating the point at which the exposed and unexposed distributions are compared to determine the incremental impact of broadcast advertising. The signal and noise learning graph 550 can display performance metrics including a lift value of 8.38 and an R² value of 0.94, consistent with the metrics shown in FIG. 5A.

In some embodiments, the signal and noise learning graph 550 can provide visual evidence of the shuffle sampling methodology used by the incrementality component 115. By analyzing the distribution of conversions across different combinations of geographic regions with varying exposure levels, the machine learning model can develop a reliable measure of the true impact of broadcast advertising and neutralize false positive signals that may result from seasonality or multicollinearity effects.

FIG. 6A depicts a validation chart 600 illustrating the difference between exposed and unexposed markets across multiple time periods before, during, and after the implementation of a broadcast media promotional cycle, in accordance with one or more aspects of the present disclosure. The validation chart 600 displays a graph with a vertical axis representing the percentage difference in per capita conversions between exposed and unexposed markets (ranging from -30.00% to approximately 60.00%) and a horizontal axis representing a timeline divided into distinct campaign phases.

As illustrated in FIG. 6A, the horizontal axis of the validation chart 600 is divided into five labeled periods: “Pre” (before the campaign started), “During” (first wave of advertising), “Dark” (hiatus or dark period with no advertising), “During” (second wave of advertising), and “Post” (after the campaign ended). A dotted line tracks the 7-day moving average of the difference between exposed and unexposed markets over time.

The validation chart 600 displays percentage values for each campaign phase. During the PRE period, the difference between exposed and unexposed markets is approximately 2.1%, representing the baseline difference before advertising began. During the first wave of advertising, the difference grows to approximately 8.7%, showing a strong advertising effectiveness signal. During the dark period (hiatus), the difference drops to approximately 0.6%, indicating that the advertising effect diminishes when no advertisements are running. During the second wave of advertising, the difference increases to approximately 13.6%, demonstrating renewed advertising effectiveness. During the POST period, the difference is approximately 6.2%, indicating a predictable advertising carryover effect after the campaign ends.

The validation chart 600 can provide visual evidence that the machine learning model’s incrementality output aligns with the raw data analyzed on a per capita conversion basis over time. The pattern of increased differences during active advertising periods and decreased differences during the hiatus period validates that the model is accurately attributing conversions to the broadcast media promotional cycle rather than to confounding factors such as seasonality.

FIG. 6B depicts a market conversion comparison chart 650 illustrating the within-market comparison of conversion performance before and during the broadcast media promotional cycle, in accordance with one or more aspects of the present disclosure. The market conversion comparison chart 650 displays a scatter plot demonstrating that markets that received advertising increased conversions during the campaign period compared to before the campaign.

The market conversion comparison chart 650 includes a horizontal axis representing a numerical scale (ranging from 0 to approximately 10,000) and a vertical axis representing per capita conversion values (ranging from 0 to approximately 40). Two data series are shown in the legend: “At Campaign Flight Dates per capita” (e.g., illustrated as empty circles) and “Before Campaign per capita” (e.g., illustrated as filled-in circles).

In some embodiments, each designated market area (DMA) can be represented by paired data points on the market conversion comparison chart 650, showing the per capita conversion rate before the campaign and the per capita conversion rate during the campaign flight dates. The DMAs displayed in FIG. 6B include Phoenix, Dallas-Fort Worth, Los Angeles, Orlando-Daytona Beach-Melbourne, San Francisco-Oakland-San Jose, Houston, Bakersfield, Odessa-Midland, Tucson (Sierra Vista), Miami-Fort Lauderdale, San Diego, Lubbock, Beaumont-Port Arthur, San Luis Obispo, Tyler-Longview (Lufkin & Nacogdoches), Monterey-Salinas, West Palm Beach-Fort Pierce, Amarillo, and San Angelo.

The positioning of the data points in the market conversion comparison chart 650 indicates that markets with higher values on the horizontal axis generally show higher per capita conversion values during the campaign period compared to before the campaign. The market conversion comparison chart 650 demonstrates that every market that received the broadcast media promotional cycle experienced an increase in per capita conversions, providing validation that the broadcast advertising had a positive impact across all geographic regions.

The market conversion comparison chart 650 can complement the validation chart 600 of FIG. 6A by showing the market-level detail underlying the aggregate difference between exposed and unexposed markets. Together, these figures can provide comprehensive validation that the machine learning model accurately attributes conversions to the broadcast media promotional cycle.

FIG. 7A depicts a channel performance interface 700 for displaying broadcast attribution data to a user, in accordance with one or more aspects of the present disclosure. In some embodiments, the channel performance interface 700 can be presented in a user interface (e.g., UI 124A-Z) of a client device (e.g., client device 120A-Z) and can be generated by the performance component 118 of the broadcast attribution and incrementality module 111.

As illustrated in FIG. 7A, the channel performance interface 700 includes a channels section with a dropdown menu labeled “Select a Channel” that enables users to filter the displayed data by specific broadcast channels. Below the dropdown menu, the channel performance interface 700 displays a data table showing performance metrics for various broadcast channels on which broadcast media promotional items of the broadcast media promotional cycle aired.

The data table within the channel performance interface 700 includes columns for Channels (Placed), Conversions, Spots, and Conversion Rate. The Channels (Placed) column identifies the name of each broadcast channel. The Conversions column displays the number of conversions attributed to broadcast media promotional items aired on each channel. The Spots column displays the total number of broadcast media promotional items (e.g., advertisements or spots) that aired on each channel during the broadcast media promotional cycle. The Conversion Rate column displays the ratio of conversions to spots for each channel, representing the effectiveness of advertising on that channel.

As illustrated in FIG. 7A, the channel performance interface 700 presents data for multiple channels. For example, the data table displays Radio Andy with 39 conversions, 215 spots, and a conversion rate of 0.181; Urban View with 39 conversions, 364 spots, and a conversion rate of 0.107; Howard 100 with 38 conversions, 359 spots, and a conversion rate of 0.106; POTUS Politics of the United States with 35 conversions, 294 spots, and a conversion rate of 0.119; CNN with 28 conversions, 468 spots, and a conversion rate of 0.060; and Howard 101 with 26 conversions, 220 spots, and a conversion rate of 0.118.

The channel performance interface 700 can enable users to view and analyze the effectiveness of broadcast advertising across different channels by comparing conversion metrics relative to the number of advertisement spots placed on each channel. Users can identify top-performing channels (e.g., channels with higher conversion rates) and underperforming channels (e.g., channels with lower conversion rates) to inform decisions about optimizing future broadcast media promotional cycles.

FIG. 7B depicts a broadcast attribution dashboard 750 displaying an overview of performance metrics for a broadcast media promotional cycle, in accordance with one or more aspects of the present disclosure. In some embodiments, the broadcast attribution dashboard 750 can be presented in a user interface (e.g., UI 124A-Z) of a client device (e.g., client device 120A-Z) and can be generated by the performance component 118 of the broadcast attribution and incrementality module 111.

In some embodiments, the broadcast attribution dashboard 750 includes a navigation menu at the top with tabs for filtering the displayed data by different types of conversion events, including All Events, Leads, Purchases, Miscs, Contents, Signups, and Registrations. The navigation menu can enable users to view attribution data for specific key performance indicators (KPIs) or for all conversion events combined.

The broadcast attribution dashboard 750 can present several key metrics in a panel layout. For example, a first panel can display “Radio Conversions” with a value of 578,219, representing the total number of conversions attributed to the broadcast media promotional cycle (in this example, a radio advertising campaign). Below the Radio Conversions metric, the broadcast attribution dashboard 750 can display “Total available conversions” with a value of 10,917,720, representing the total number of conversion events that occurred during the broadcast media promotional cycle across all channels and mediums. The broadcast attribution dashboard 750 can display “5.3% Attributed to this campaign,” indicating the percentage of total conversions that are attributed to the broadcast media promotional cycle.

In some embodiments, a second panel of the broadcast attribution dashboard 750 can display “Radio Campaign Reach” with a value of 7,486,363, representing the total number of unique individuals reached by the broadcast media promotional cycle. Below the Radio Campaign Reach metric, the broadcast attribution dashboard 750 displays “13,261 Spots,” indicating the total number of broadcast media promotional items (e.g., advertisements or spots) that aired during the broadcast media promotional cycle.

In some embodiments, a third panel of the broadcast attribution dashboard 750 displays “10% Pop Reached,” indicating that the broadcast media promotional cycle reached approximately 10 percent of the population within the geographic regions where the campaign aired.

The broadcast attribution dashboard 750 can provide users with a high-level overview of the broadcast media promotional cycle performance, including the total attributed conversions, the reach of the campaign, and/or the percentage of the population reached. This information can be used by advertisers to evaluate the effectiveness of the broadcast media promotional cycle and to compare the broadcast attribution measurement with digital attribution measurements for corresponding digital promotional cycles, in embodiments.

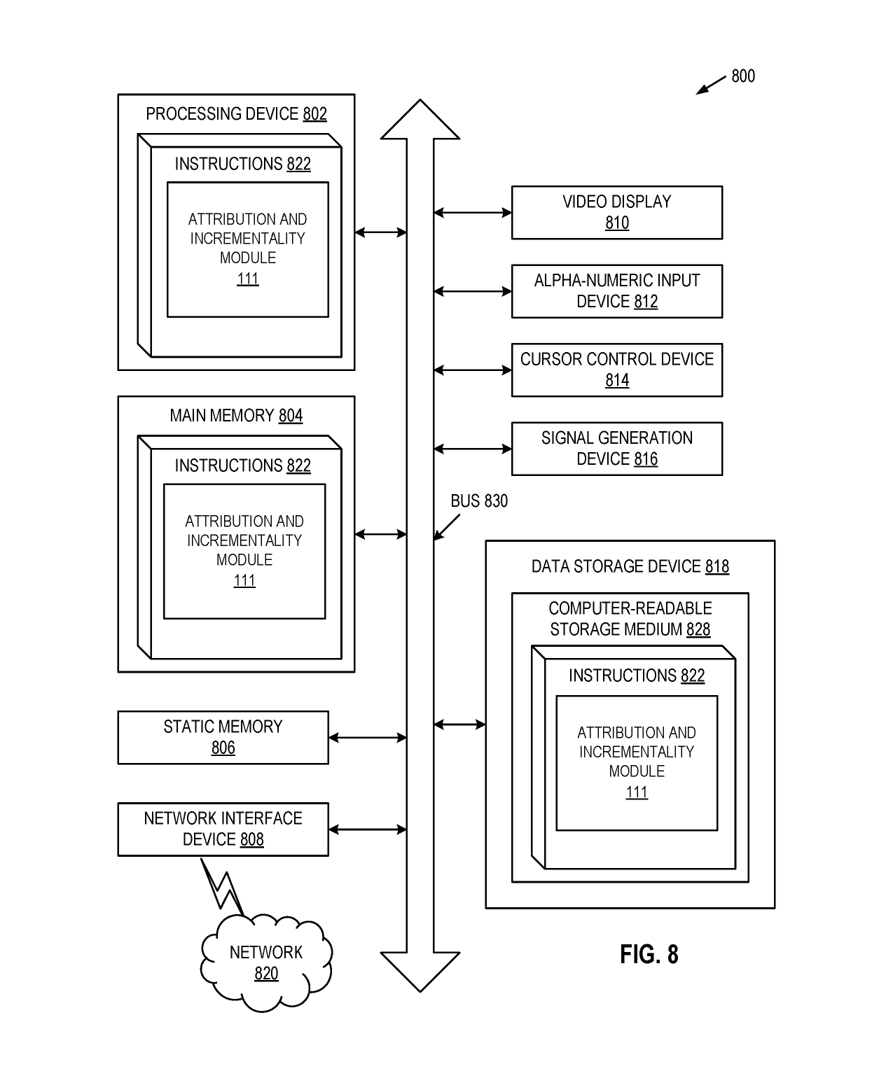

FIG. 8 depicts a block diagram of an example computing system 800 operating in accordance with one or more aspects of the present disclosure. In various illustrative examples, computer system 800 may correspond to any of the computing devices within system architecture 100 of FIG. 1. In one implementation, the computer system 800 may be the server device 112.

In certain implementations, computer system 800 may be connected (e.g., via a network, such as a Local Area Network (LAN), an intranet, an extranet, or the Internet) to other computer systems. Computer system 800 may operate in the capacity of a server or a client computer in a client-server environment, or as a peer computer in a peer-to-peer or distributed network environment. Computer system 800 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term "computer" shall include any collection of computers that individually or jointly execute a set (or multiple sets) of instructions to perform any one or more of the methods described herein.

In a further aspect, the computer system 800 may include a processing device 802, a volatile memory 804 (e.g., random access memory (RAM)), a non-volatile memory 806 (e.g., read-only memory (ROM) or electrically-erasable programmable ROM (EEPROM)), and a data storage device 816, which may communicate with each other via a bus 808.

Processing device 802 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 800 may further include a network interface device 822. Computer system 800 also may include a video display unit 810 (e.g., an LCD), an alphanumeric input device 812 (e.g., a keyboard), a cursor control device 814 (e.g., a mouse), and a signal generation device 820.

Data storage device 816 may include a non-transitory computer-readable storage medium 824 on which may store instructions 826 encoding any one or more of the methods or functions described herein, including instructions implementing broadcast attribution and incrementality module 111 of FIG. 1 for implementing the methods described herein.

Instructions 826 may also reside, completely or partially, within volatile memory 804 and/or within processing device 802 during execution thereof by computer system 800, hence, volatile memory 804 and processing device 802 may also constitute machine-readable storage media.

While computer-readable storage medium 824 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

In the foregoing description, numerous details are set forth. It will be apparent, however, to one of ordinary skill in the art having the benefit of this disclosure, that the present disclosure can be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving”, “identifying”, “determining”, “generating”, “assigning”, “inputting”, “selecting”, “training”, “moving”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

For simplicity of explanation, the methods are depicted and described herein as a series of acts. However, acts in accordance with this disclosure can occur in various orders and/or concurrently, and with other acts not presented and described herein. Furthermore, not all illustrated acts can be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

Certain implementations of the present disclosure also relate to an apparatus for performing the operations herein. This apparatus can be constructed for the intended purposes, or it can comprise a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

Reference throughout this specification to “one implementation” or “an implementation” means that a particular feature, structure, or characteristic described in connection with the implementation is included in at least one implementation. Thus, the appearances of the phrase “in one implementation” or “in an implementation” in various places throughout this specification are not necessarily all referring to the same implementation. In addition, the term “or” is intended to mean an inclusive “or” rather than an exclusive “or.” Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
receiving, by a processing device, an event log corresponding to a broadcast media promotional cycle, wherein the event log comprises a plurality of entries, wherein each entry of the plurality of entries comprises at least region data, date data, and promotion placement data;
processing the event log to determine a first conversion rate corresponding to the broadcast media promotional cycle;
processing a subset of the event log to determine a second conversion rate corresponding to the broadcast media promotional cycle, wherein the subset comprises a subset of the plurality of entries comprising the plurality of entries without the promotion placement data;
determining, based on the first conversion rate and the second conversion rate, an incrementality value corresponding to the broadcast media promotional cycle;
determining a baseline attribution of the broadcast media promotional cycle corresponding to at least one broadcast media promotional item of the broadcast media promotional cycle;
determining an incremental contribution corresponding to the broadcast media promotional cycle by applying the incrementality value to the baseline attribution of the broadcast media promotional cycle;
determining, based on the incremental contribution corresponding to the broadcast media promotional cycle, one or more performance measurements corresponding to the broadcast media promotional cycle; and
providing, to a user device, at least one of the incremental contribution or the one or more performance measurements corresponding to the broadcast media promotional cycle.

2. The method of claim 1, further comprising:
determining, based on the incremental contribution corresponding to the broadcast media promotional cycle, a modified implementation of a second broadcast media promotional item of the broadcast media promotional cycle;
generating, based on the modified implementation, an instruction to implement the modified implementation; and
providing, to the user device, the instruction to implement the modified implementation.

3. The method of claim 2, wherein the modified implementation comprises at least one of a change in a time of day, a genre, a station, a format, or a version of the second broadcast media promotional item corresponding to an improved performance.

4. The method of claim 1, wherein the baseline attribution, the incrementality value, and the incremental contribution correspond to a particular lookback window of a duration of the broadcast media promotional cycle.

5. The method of claim 4, wherein the baseline attribution is determined by multiplying a rolling reach of the broadcast media promotional cycle by a total number of conversion events in a geographical region during the particular lookback window, wherein the rolling reach of the broadcast media promotional cycle represents an accumulation of incremental reach within a population.

6. The method of claim 1, wherein the baseline attribution comprises at least one of a reach or a frequency of broadcast media promotional items of the broadcast media promotional cycle.

7. The method of claim 1, wherein the one or more performance measurements comprise at least one of a return on advertisement spend or a return on investment.

8. The method of claim 1, wherein processing the event log to determine the first conversion rate corresponding to the broadcast media promotional cycle comprises:
providing, as a first input, the event log to an artificial intelligence (AI) model trained to provide a conversion rate corresponding to the broadcast media promotional cycle; and
receiving, as a first output from the AI model, the first conversion rate corresponding to the broadcast media promotional cycle.

9. The method of claim 8, further comprising:
providing, as additional first input, time series data corresponding to the broadcast media promotional cycle.

10. The method of claim 8, wherein the event log provided as the first input to the AI model comprises input features comprising at least one of:
a designated market area feature comprising categorical data identifying a geographic region associated with each entry of the plurality of entries;
a day of week feature comprising categorical data identifying a day of the week associated with each entry of the plurality of entries;
a day number feature comprising numerical data representing a sequential day number within the broadcast media promotional cycle;
a channel feature comprising numerical data representing a number of broadcasts for each channel on which broadcast media promotional items aired;
a broadcast hour feature comprising numerical data representing a number of broadcasts for each hour of a day during which broadcast media promotional items aired;
a broadcast day of week feature comprising numerical data representing a number of broadcasts for each day of the week during which broadcast media promotional items aired;
a promotion length feature comprising numerical data representing a number of broadcasts for each promotion length of the broadcast media promotional items; or
a pixel action feature comprising numerical data representing a number of pixel actions on one or more previous days, wherein a pixel action corresponds to a conversion event tracked by a tracking pixel.

11. The method of claim 1, wherein processing the subset of the event log to determine the second conversion rate corresponding to the broadcast media promotional cycle comprises:
providing, as a second input, the subset of the event log to an artificial intelligence (AI) model trained to provide a conversion rate corresponding to the broadcast media promotional cycle; and
receiving, as a second output from the AI model, the second conversion rate corresponding to the broadcast media promotional cycle.

12. The method of claim 11, further comprising:
providing, as additional second input, time series data corresponding to the broadcast media promotional cycle.

13. The method of claim 11, wherein the subset of the event log provided as the second input to the AI model comprises input features comprising at least one of:
a designated market area feature comprising categorical data identifying a geographic region associated with each entry of the plurality of entries;
a day of week feature comprising categorical data identifying a day of the week associated with each entry of the plurality of entries;
a day number feature comprising numerical data representing a sequential day number within the broadcast media promotional cycle; or
a pixel action feature comprising numerical data representing a number of pixel actions on one or more previous days, wherein a pixel action corresponds to a conversion event tracked by a tracking pixel; and
wherein the subset excludes at least one of a channel feature, a broadcast hour feature, a broadcast day of week feature, or a promotion length feature.

14. The method of claim 1, wherein the incremental contribution provides a broadcast attribution measurement proportionate to a digital attribution measurement for a corresponding digital promotional cycle, and wherein the method further comprises:
comparing the broadcast attribution measurement to the digital attribution measurement for the corresponding digital promotional cycle;
determining, based on the comparing, an adjusted implementation of at least one of the broadcast media promotional cycle or the corresponding digital promotional cycle, wherein the adjusted implementation reduces computing resources used to implement the at least one of the broadcast media promotional cycle or the corresponding digital promotional cycle by modifying a schedule to remove one or more underperforming promotional items; and
providing, to the user device, an instruction to implement the adjusted implementation.

15. The method of claim 1, wherein the incremental contribution provides a broadcast attribution measurement that is comparable to a digital attribution measurement for a corresponding digital promotional cycle, wherein the comparability is achieved by combining the baseline attribution derived from random duplication of a rolling reach with an incrementality value to produce an attribution count on par with digital path-to-purchase attribution counting.

16. The method of claim 1, wherein determining the incrementality value comprises:
performing shuffle sampling by selecting, based on the region data, a plurality of combinations of geographic regions from the plurality of entries, wherein the plurality of geographic regions comprise geographic regions having varying degrees of exposure to the broadcast media promotional cycle;
generating, for each combination of geographic regions of the plurality of geographic regions, a distribution of exposure versus non-exposure to the broadcast media promotional cycle;
separating, based on the distribution, a signal of broadcast advertising impact from noise comprising at least one of seasonality effects, other advertising mediums, or marketplace effects;
adjusting, using a machine learning model, the incrementality value until false positive signals are neutralized; and
determining, based on the adjusted incrementality value, a measure of incremental contribution caused by the broadcast media promotional cycle.

17. The method of claim 1, wherein determining the incrementality value comprises:
identifying, from the plurality of entries, a first set of geographic regions that received the broadcast media promotional cycle and a second set of geographic regions that did not receive the broadcast media promotional cycle;
determining, using an artificial intelligence model, a first predicted conversion rate for the first set of geographic regions based on the promotion placement data;
generating a counterfactual scenario by applying advertising weight from the first set of geographic regions to the second set of geographic regions that did not receive the broadcast media promotional cycle;
determining, using the AI model, a second predicted conversion rate for the counterfactual scenario;
detecting, based on a comparison of the first predicted conversion rate and the second predicted conversion rate, whether a false positive signal exists;
adjusting, in response to detecting the false positive signal, the incrementality value until the false positive signal is neutralized; and
identifying, based on the adjusted incrementality value, an impact of the broadcast media promotional cycle attributable to the broadcast media promotional items.

18. The method of claim 1, wherein determining the incrementality value comprises:
identifying, from the region data of the plurality of entries, a plurality of geographic regions having varying volumes of advertising delivery, wherein the varying volumes comprise at least a first volume level, a second volume level, and a third volume level;
performing a cross-sectional regional analysis by comparing conversion rates across the plurality of geographic regions based on the varying volumes of advertising delivery;
generating a time series model representing trends in conversions over a time period corresponding to the broadcast media promotional cycle;
combining the time series model with the cross-sectional regional analysis to address multicollinearity, wherein multicollinearity comprises multiple factors simultaneously influencing conversion events; and
determining, based on the time series model and the cross-sectional regional analysis, the incrementality value representing an incremental contribution of the broadcast media promotional cycle to the conversion events.

19. A system comprising:
a memory device; and
a processing device operatively coupled to the memory device, the processing device to execute instructions from the memory to:
receive, by a processing device, an event log corresponding to a broadcast media promotional cycle, wherein the event log comprises a plurality of entries, wherein each entry of the plurality of entries comprises at least region data, date data, and promotion placement data;
process the event log to determine a first conversion rate corresponding to the broadcast media promotional cycle;
process a subset of the event log to determine a second conversion rate corresponding to the broadcast media promotional cycle, wherein the subset comprises a subset of the plurality of entries comprising the plurality of entries without the promotion placement data;
determine, based on the first conversion rate and the second conversion rate, an incrementality value corresponding to the broadcast media promotional cycle;
determine a baseline attribution of the broadcast media promotional cycle corresponding to at least one broadcast media promotional item of the broadcast media promotional cycle;
determine an incremental contribution corresponding to the broadcast media promotional cycle by applying the incrementality value to the baseline attribution of the broadcast media promotional cycle, wherein the incremental contribution provides a broadcast attribution measurement proportionate to a digital attribution measurement for a corresponding digital promotional cycle;
determine, based on the incremental contribution corresponding to the broadcast media promotional cycle, one or more performance measurements corresponding to the broadcast media promotional cycle;
compare the broadcast attribution measurement to the digital attribution measurement for the corresponding digital promotional cycle;
determine, based on the comparing, an adjusted implementation of at least one of the broadcast media promotional cycle or the corresponding digital promotional cycle, wherein the adjusted implementation reduces computing resources used to implement the at least one of the broadcast media promotional cycle or the corresponding digital promotional cycle by modifying a schedule to remove one or more underperforming promotional items; and
provide, to a user device, an instruction to implement the adjusted implementation and at least one of the incremental contribution or the one or more performance measurements corresponding to the broadcast media promotional cycle.

20. A non-transitory computer-readable storage medium comprising instructions that, when executed by a processing device, cause the processing device to:
receive, by a processing device, an event log corresponding to a broadcast media promotional cycle, wherein the event log comprises a plurality of entries, wherein each entry of the plurality of entries comprises at least region data, date data, and promotion placement data;
process the event log to determine a first conversion rate corresponding to the broadcast media promotional cycle;
process a subset of the event log to determine a second conversion rate corresponding to the broadcast media promotional cycle, wherein the subset comprises a subset of the plurality of entries comprising the plurality of entries without the promotion placement data;
determine, based on the first conversion rate and the second conversion rate, an incrementality value corresponding to the broadcast media promotional cycle;
determine a baseline attribution of the broadcast media promotional cycle corresponding to at least one broadcast media promotional item of the broadcast media promotional cycle;
determine an incremental contribution corresponding to the broadcast media promotional cycle by applying the incrementality value to the baseline attribution of the broadcast media promotional cycle;
determine, based on the incremental contribution corresponding to the broadcast media promotional cycle, one or more performance measurements corresponding to the broadcast media promotional cycle;
determine, based on the incremental contribution corresponding to the broadcast media promotional cycle, a modified implementation of a second broadcast media promotional item of the broadcast media promotional cycle;
generate, based on the modified implementation, an instruction to implement the modified implementation and
provide, to a user device, the instruction to implement the modified implementation and at least one of the incremental contribution or the one or more performance measurements corresponding to the broadcast media promotional cycle.
